(19) United States
(12) Patent Application Publication
(10) Pub. No.: US 2015/0257394 A1
(43) Pub. Date: Sep. 17, 2015

(54) TEA EXTRACTS AND USES IN PROMOTING PLANT GROWTH

(71) Applicant: PLANT ACTIVITY LTD., Winnipeg (CA)

(72) Inventor: Jarrett Warren Chambers, Winnipeg (CA)

(21) Appl. No.: 14/436,426

(22) PCT Filed: Oct. 17, 2013
(86) PCT No.: PCT/US13/65463

§ 371 Date: Apr. 16, 2015

Related U.S. Application Data
(63) Continuation-in-part of application No. 13/827,923, filed on Mar. 14, 2013.
(60) Provisional application No. 61/715,745, filed on Oct. 18, 2012.

(51) Int. Cl. A01N 65/08

(52) U.S. Cl. CPC A01N 65/08

(57) ABSTRACT

The present disclosure provides compositions that comprise extracts of oxidized tea {e.g., black tea) and methods for using such extracts in promoting plant growth, health or yield including seed germination, root development, vegetative growth, flowering, maturity, and plant yield. The present disclosure also provided portions of plants {e.g., seeds) treated with the extracts of oxidized tea.

### BACKGROUND

1. Technical Field

The present disclosure relates to compositions that comprise extracts from oxidized tea, their uses in promoting plant growth, health or yield, and seeds treated with such extracts.

2. Description of the Related Art

Tea from the camellia senensis plant is the most popular beverage in the world. Tea was first discovered over 4,000 years ago in China and has been used as a beverage ever since. Various kinds of tea from this plant have been prepared for thousands of years. There are three primary categories of tea from camellia senensis based upon three different states of oxidation of the leaves: green, oolong and black tea. Green tea is made from leaves that have undergone only a slight degree of oxidation. Oolong tea has been subjected to more oxidation, while black tea has been extensively oxidized.

Some may refer to this process as fermentation. Strictly speaking, however, it is not a microbial mediated fermentation like what takes place in the making of beer, wine, or other alcoholic drinks. It is an oxidation mediated by the natural enzymes present in the tea leaves themselves.

Tea was recommended and used in both Chinese and Indian traditional medicine for many centuries. More recently, clinical studies have documented the human health benefits of tea, especially for its role as a cancer preventing and fighting anti-oxidant.

Extracts of green tea are primarily composed of low molecular weight caffeine and polyphenols. These polyphenols including the catechin group have been found to have various physiological effects on both the individual and the cellular level. The oxidation process transforms the polyphenols into a wider range of compounds, including theaflavins and thearubigins.

### BRIEF SUMMARY

In one aspect, the present disclosure provides a method for promoting plant growth, health or yield that comprises treating at least a portion of a plant with an extract of oxidized tea at an amount effective in promoting growth, health or yield of the plant.

The plant may be a crop plant, such as a pulse crop.

Exemplary plants include without limitation corn, soybean, wheat, rice, barley, oats, canola, or turf grass.

The portion of the plant that may be treated with an oxidized tea extract includes a seed, roots, one or more leaves, one or more stems, or a combination thereof. In certain embodiments, a whole plant may be treated. In certain other embodiments, the tea extract is applied to soil around the plant.

In certain embodiments, the oxidized tea is a black tea.

In some embodiments, the oxidized tea extract comprise at least 15%, 20%, 25%, 30%, 35%, 40%, 45%, 50%, 55%, 60%, 65%, or 70% thearubigins by dry weight.

In one embodiment, the step of treating comprises priming a seed with an oxidized tea extract.

The oxidized tea extract may increase or enhance one or more of seed germination rate, seed germination potential and final stand, root length, root surface area, early vegetative growth of the plant, root to shoot ratio, rhizosphere, root nodule formation, plant vigor, flowering rate, maturity rate, seedling disease suppression, nematode suppression, chlorophyll density, pollination success, grain fill, plant yield, and plant protein content.

In certain embodiments, the method disclosed herein may further comprise treating the portion of the plant with one or more additional plant protection or nutritional component, such as fertilizers, inoculants, biostimulants, activators (e.g., phosphorous acid) and plant protection chemicals. The fertilizer may comprise plant micronutrient(s) iron, zinc, or both. The biostimulant may be selected from plant hormones, seaweed extracts, and humic substances. The plant protection chemical may be selected from herbicides, insecticides, and fungicides. Preferably, the plant protection or nutritional component includes ascorbic acid.

The portion of the plant may be treated with the tea extract and the additional plant protection or nutritional component(s) separately. Alternatively, it may be treated with a composition comprising the tea extract and the additional component(s). The composition may further comprise (a) a preservative, (b) a stabilizer, (c) a seed priming agent, (d) both a preservative and a stabilizer, (e) both a stabilizer and a seed priming agent, (f) both a preservative and a seed priming agent, or (g) all of a preservative, a stabilizer, and a seed priming agent.

In another aspect, the present disclosure provides a composition that comprises (i) an extract of oxidized tea, and (ii) one or more additional plant protection or nutritional components other than a seaweed extract or ascorbic acid.

In a further aspect, the present disclosure provides a seed composition that comprises (i) an extract of oxidized tea, and (ii) a seed. In certain embodiments, the seed composition further comprises one or more additional plant protection or nutritional components. The seed composition may further comprise (a) a preservative, (b) a stabilizer, (c) a seed priming agent, (d) both a preservative and a stabilizer, (e) both a stabilizer and a seed priming agent, (f) both a preservative and a seed priming agent, or (g) all of a preservative, a stabilizer, and a seed priming agent. Preferably, the seed composition further comprises ascorbic acid in addition to an extract of oxidized tea and a seed.

In certain embodiments, the seed is coated with the oxidized tea extract or a composition that comprises the oxidized tea extract. In some embodiments, the seed coated with the oxidized tea extract may comprise a second coating. The seed may have been primed with the oxidized tea extract or a composition that comprises the oxidized tea extract. Alternatively, the seed may be soaked with the oxidized tea extract or a composition that comprises the oxidized tea extract.

In the following description, any ranges provided herein include all the values in the ranges. It should also be noted that the term “or” is generally employed in its sense including “and/or” (i.e., to mean either one, both, or any combination thereof of the alternatives) unless the content clearly dictates otherwise. Also, as used in this specification and the appended claims, the singular forms “a,” “an,” and “the” include plural referents unless the content clearly dictates otherwise.

### BRIEF DESCRIPTION OF THE SEVERAL VIEWS OF THE DRAWINGS

FIG. 1 is a graph showing the effects of various treatments (i.e., black tea extract, humic substance and green tea extract) on germination of the treated wheat seeds at 72 hours after the initial watering.

FIG. 2 is a graph showing root weight and shoot weight of seedlings at 9 days after the initial watering of seeds treated with black tea extract, humic substance, and green tea extract.

FIG. 3 is a graph showing effects of various black tea extracts on germination at 54 hours after the initial watering of treated wheat seeds.

FIGS. 4A and 4B are graphs showing effects of Lipton yellow label tea extract in combination with RELEAF™ on wheat root growth: root length (cm) (FIG. 4A) and root surface area (cm²) (FIG. 4B).

FIG. 5 is a graph showing effects of Darjeeling tea extract as seed treatment on turf grass germination.

FIG. 6 is a picture that shows seedlings at 148 hours after the first watering germinated from Agrostis stolonifera CV 007 seeds treated with Darjeeling tea extract (left) and from untreated seeds (right).

FIG. 7 is a graph showing the effects of black tea extracts on wheat root growth (cm). UTC: untreated control.

FIG. 8 is a graph showing the effects of black tea extract in combination with ascorbic acid or without ascorbic acid on germination of the treated wheat seeds at 24 hours after the initial watering.

FIG. 9 is a graph showing the effects of black tea extract in combination with ascorbic acid or without ascorbic acid on germination of the treated wheat seeds at 48 hours after the initial watering.

### DETAILED DESCRIPTION

The present disclosure provides methods for promoting plant growth, health, or yield by treating at least a portion of a plant with an extract of oxidized tea, compositions that comprise an extract of oxidized tea and a plant growth regulator (i.e., plant protection or nutritional component), and seed compositions that comprise an extract of oxidized tea and a seed. The methods, compositions, and treated plants or portions thereof are provided based on a surprising discovery that extracts of oxidized tea (e.g., black tea) have beneficial effects on plant growth, health or yield.

In one aspect, the present disclosure provides a method for promoting plant growth, health or yield that comprises treating at least a portion of a plant with an extract of oxidized tea at an amount effective in promoting the growth, health or yield of the plant.

Tea is most widely consumed beverage in the world and is produced from the leaves, buds or twigs of the plant species, Camellia sinensis.

The types of tea are distinguished by their processing. After picking, leaves of Camellia sinensis soon begin to wilt and oxidize if not dried quickly. This process results in starch being converted into sugars and leaves turning progressively darker. To stop the oxidation process, water is removed from the leaves via heating at a predetermined stage.

Tea is traditionally classified based on the degree or period of oxidation the leaves have undergone. For green tea, the oxidation process is stopped after a minimal amount of oxidation by application of heat. Tea leaves are then left to dry. Green tea is processed within one to two days of harvesting. For oolong, oxidation is stopped somewhere between the standards for green tea and black tea. The oxidation process takes typically two to three days. For black tea (which may also called “red tea”), the tea leaves are allowed to extensively or completely oxidize. The oxidation process typically takes around two weeks and up to one month. Other methods that vary in oxidation temperatures and durations may also be used to prepare different types of tea, such as those described in Willson and Clifford, Tea: Cultivation to Consumption, Chapman and Hall, London, 1992.

The term “oxidized tea” as used herein refers to tea that has been subject to oxidation longer than the period for making green tea. Exemplary oxidized teas include oolong, phu-er, and black tea. Exemplary black teas include Kenya, Darjeeling, Lipton blend, Vietnam dust, Turkish, Tiger Hill, Kenyan BP1, Java broken, Indian BB21, Darjeeling white leaf, Ceylon UVA, Ceylon standard EBOP, Ceylon GMD, Assam, and Argentine BOP black teas.

The leaves of tea plants contain large amounts (10-25% dry weight) of monomeric flavonoids (i.e., catechins). During oxidation, catechins are condensed into theaflavins (dimers) and thearubigins (polymers). The earlier stage of oxidation is responsible for creating theaflavins, while the later stage of oxidation forms thearubigins. Dry green tea contains mostly catechins (3.5 times that of black dry tea), and dry black tea contains 99 times more theaflavins and 45 times more thearubigins compared to dry green tea (Bhagwat et al., Flavonoid composition of tea: Comparison of black and green teas, available at www.nal.usda.gov/fnic/foodcomp/Data/Other/IFT2003_TeaFlay.pdf). About 10% of the flavonoids in black tea are catechins, 10% are theaflavins, and 70% are thearubigins (Mulder et al., Am J Clin Nutr 81(suppl):256S-60S, 2005).

The term “tea extract” refers to water soluble substances extracted from tea. The tea extract may be prepared by adding water to tea and to steep the tea in water for a period of time. The temperature of water may vary, for example, from 30° C. to 105° C., such as from 40° C. to 95° C. The incubation time may vary, for example, for a period of 1 minute to 5 hours, such as 10 minutes to 4 hours. Typically, high temperature of water requires less incubation time. After incubation, the brew may be filtered, and the filtrate may be further extracted using an organic solvent (e.g., ethyl acetate) (see, e.g., Fujihara et al., Biosci. Biotechnol. Biochem. 71(3): 711-9, 2007). The aqueous fraction from the further organic solvent extract contains water soluble substances from tea and may still be deemed as “tea extract” as defined herein. The tea extract may be in its initial liquid form, or may be dried to be in a solid form.

The “extract of oxidized tea” refers to water soluble substances extracted from oxidized tea. The extract may be prepared according to the above description related to the more generic term “tea extract.”

The extract of an oxidized tea comprises at least 5% (dry weight) of thearubigins (i.e., at least 5% of the solids in the oxidized tea extract is thearubigins), such as at least 6%, 7%, 8%, 9%, 10%, 15%, 20%, 25%, 30%, 35%, 40%, 45%, 50%, 55%, 60% (dry weight) of thearubigins. At least 10% (dry weight), such as at least 15%, 20%, 25%, 30%, 35%, 40%, 45%, 50%, 55%, 60%, 65% or 70% (dry weight), of the flavonoids in an oxidized tea extract are thearubigins. Thearubigins are brownish water-soluble, but ethylacetate-insoluble (see, Roberts, Economic Importance of Flavonoid Substances: Tea Fermentation, in: Geissman (Ed.), The Chemistry of Flavonoid Compounds, Pergamon Press, Oxford, 1962, pp. 1468-1512; Roberts et al., J. Sci. Food Agric. 8:72-80, 1959). The amount of thearubigins in a tea extract is determined using the method of UV-VIS spectrophotometry applying the analyzer of Cecil CE 7210 in the wavelength of 825 nm according to Ostadalova et al., Journal of Food Technology 9(2):50-6, 2011. Alternative methods described in Roberts 1962 and Roberts et al. 1959, supra, and Kuhnert, Archives of Biochemistry and Biophysics 501:37-51, 2010 may also be used in measuring the amount of thearubigins in a tea extract.

One or more preservatives may be added to extracts of oxidized tea to preserve the activities of the extracts and extend the shelf life of the extracts. Suitable preservatives will not significantly reduce the activities of the extracts, but prevent growth of bacteria, yeast or fungi in liquid tea extracts. Exemplary preservatives include potassium sorbate, citric acid, sodium benzoate, and methyl paraben (e.g., 0.5%-5%, such as 1%, solution of methyl paraben that has been pre-dissolved in hexalene glycol (30:1 ratio of hexalene glycol to methyl paraben)).

One or more stabilizers may be added to extracts of oxidized tea to reduce precipitates from the extracts at cold temperatures. Exemplary stabilizers includes ascorbic acid (or its salts), carrageenan (linear sulfated polysaccharides extracted from red seaweed), AQUALON™, BONDWELL™ and BLANOSE™ cellulose gum (Ashland Inc., Covington, Ky.), and SUPERCOL™ guar gum (Ashland Inc., Covington, Ky.). 0.5 g to 5 g (e.g., about 0.5 g to about 1.5 g, about 1.5 g to about 3 g, about 3 g to about 5 g, or about 1, 2, 3, 4, or 5 g) of ascorbic acid may be added to 100 ml (or to 1000 ml of a 10 fold dilution of) oxidized tea extracts prepared by extracting 20 g oxidized tea in 200 ml of water at 95° C. for 120 minutes (see, Example 1) to prevent the tea extract solution from forming insoluble precipitates. 0.1 to 1′)/0 (w/v) of carrageenan may be added to 4 to 20 fold dilution of oxidized tea extracts prepared as described above to prevent the tea extract solution from forming insoluble precipitates.

Plants that may be treated with extracts of oxidized tea include dicotyledons and monocotyledons, non-transgenic plants and transgenic plants. Preferred plants are crop plants (i.e., crops grown primarily for human consumption such as cereal crops), turf grass (e.g., sports turf), vegetables (e.g., leafy and salad vegetables, flowering and fruiting vegetables, legumes, bulb and stem vegetables, and root and tuber vegetables), pulse crops (i.e., grain legumes—plants belonging to the family Leguminosae (alternatively Fabaceae) grown primarily for their edible grains or seeds, including adzuki bean, broad bean, vetch, common bean, chick pea, cowpea, guar bean, hyacinth bean, lentil, lima bean, lupin, mung bean, pea, peanut, pigeon pea, soybean, and tepary bean), grapevines, pome and stone fruit orchard crops, sugar cane, sugar beets, tropical fruits, seed crops, and oil plants. Exemplary plants include corn, soybean, wheat, rice, canola and turf grass. Additional exemplary plants include those listed in U.S Patent Application Publication Nos. 2004/0023802 and 2012/0015805, which are incorporated herein by reference.

Portions of a plant that may be treated with extracts of oxidized tea include seeds, roots, leaves, stems, flowers, fruits, and combinations thereof. Specifically tea extracts can be applied in an aqueous solution either to the roots via a soil application, irrigation, or application with liquid or granular fertilizers. Another specific method of application can be made to the above ground plant parts via a foliar spray. In certain embodiments, a whole plant is treated with extracts of oxidized tea.

A portion of a plant may be treated by contacting the portion of the plant with an extract of oxidized tea. For example, seeds may be treated by applying a liquid form of tea extract either alone or with one or more additional plant protection or plant nutrition components (e.g., fertilizers; inoculants; biostimulants such as plant hormones, humic substances, complex organic materials, beneficial chemical elements, sea plant extracts, chitin and chitosan derivatives, and free amino acids and other N-containing substances; and plant protection chemicals such as herbicides, insecticides, fungicides, bactericides, molluscicides, nematocides, acaricides, anti-microbials, and the like), preservatives, stabilizers, and/or seed priming agents to the seeds for a relatively short period of time (e.g., less than an hour to a few hours) and allow it to dry after application. The treated seeds may be sowed soon after the treatment or after being stored for long periods prior to sowing.

Extracts of oxidized tea may also be used in seed priming. Thus, the method for promoting plant growth, health or yield provided herein may comprise priming a seed with an extract of oxidized tea. “Seed priming” refers to the process that exposes seeds to partial imbibition that allows the metabolic activity necessary for germination to occur, but prevents radical emergence. During seed priming, seeds are exposed to an aqueous solution that may comprise a seed priming agent for a period of time (e.g., several hours to several days). Seeds are then rinsed with water, and re-dried to about their original moisture contents. An oxidized tea extract may be used as the aqueous solution to which seeds are exposed. In addition, one or more additional seed priming agents may be added to the oxidized tea extract. “Seed priming agents” refers to compounds or compositions useful for priming seeds to improve seedling emergence and/or early growth under normal conditions or under stress. Exemplary seed priming agents include chitosan (e.g., 0.25%-0.75% (w/v) chitosan solutions), polyethylene glycol (PEG) (e.g., −0.6 MPa PEG 8000), and ascorbic acid (e.g., 0.5-5 mM, such as 2 mM, solution of ascorbic acid). The amount of a seed priming agent may be adjusted when used in combination with an oxidized tea extract.

Another possible treatment is a “seed soak” in which the seeds are soaked in an oxidized tea extract or a composition that comprises an oxidized tea extract and one or more additional plant protection or plant nutritional components for a period of time (e.g., for 1 to 6 hours) before they are sown in the field. In certain embodiments, seeds may be soaked for a longer period time, such as for 1 to 10 days or even longer. The seeds may even germinate in the tea extract or the composition that comprises the tea extract, and the resulting seedlings are then planted in the field.

Additional methods for treating seeds with tea extracts are provided below in connection with preparing seed compositions that comprise seeds treated with extracts of oxidized tea.

To treat leaves, a tea extract may be applied to plant leaves alone or in combination with one or more plant protection or plant nutritional components as a broadcast or directed spay over the top of the plant.

Various methods may be used to apply a tea extract either alone or in combination with one or more plant protection or plant nutritional components in soil around seeds or plants to treat the seeds or the roots of the plants indirectly via the soil. Exemplary methods include in-furrow or pop-up application of a tea extract on the seed at planting, pre-plant banded near the seed, pre- or post-plant application of a tea extract with liquid or granular fertilizer, applying a liquid tea extract to granular fertilizer and allowed it to dry prior to applying the dried granular fertilizer in soil, mixing a liquid tea extract with a liquid fertilizer prior to applying to soil, post-plant knifing or side-dress application of a tea extract alone or in combination with one or more additional plant protection chemicals or nutritional components in a band between the plant and furrow bottom, broadcast or directed spray of tea extract in water or in combination with one or more additional plant protection chemicals or nutritional components to soil, or applying a tea extract alone or a mixture of tea extract and one or more additional plant protection chemicals or nutritional components with irrigation water to be absorbed by roots and foliage.

As indicated above, treating a portion of a plant with an extract of oxidized tea promotes the growth of the plant. As used herein, “promoting plant growth, health or yield” refers to promoting, enhancing or increasing one or more parameters related to plant growth, health or yield, including: seed germination rate, seed germination potential and final stand (i.e., the number of plants per unit of area), root length, root surface area, early vegetative growth (e.g., growth within 1, 2, 3, 4 or 5 weeks after a seed is planted), root to shoot ratio, rhizosphere (i.e., the zone of soil surrounding a plant root where the biology and chemistry of the soil are influenced by the root), root nodule formation, vigor (e.g., plant weight, plant height, plant canopy, and plant visual appearance), flowering rate, maturity rate (i.e., the length of time to harvest from the day that a seed is planted), seedling or plant disease suppression, nematode suppression, chlorophyll density, pollination success, grain fill, plant yield, and other harvest quality parameters including but not limited to sugar content, firmness, color, protein, etc. Promoting, enhancing or increasing seed germination rate, seed germination potential and final stand include increase seed germination rate, seed germination potential and final stand under normal conditions or under stress, such as high or low temperature stress, drought, or high salt stress.

A treatment “improves plant growth, health or yield” if a plant with the treatment has enhanced or increased growth, health or yield compared to a control untreated plant.

“An amount effective in promoting plant growth, health or yield” refers to the amount of tea extract that is effective in promoting plant growth, health or yield.

Concentrations of tea extracts may be determined based on the total organic carbon (TOC) of the tea extracts. The total organic carbon may be determined using standard procedures (see, e.g., Bernard et al., Determination of Total Carbon, Total Organic Carbon and Inorganic Carbon in Sediments, available at www.tdi-bi.com/analytical-services/environmental/NOAA methods/TOC.pdf).

The amounts effective in promoting plant growth, health or yield may be determined or adjusted depending on various factors, including the plants to which tea extracts are applied, the manners in which tea extracts are applied, environmental factors to which the plants are subject (e.g., temperature), and other factors apparent to a person skilled in the field of plant sciences.

For example, for “seed soak,” the TOC of a tea extract may be from 1 to 200 mg/l, such as from 1-10 mg/l, 10-20 mg/l, 20-40 mg/l, 40-60 mg/l, 80-100 mg/l, 100-120 mg/l, 120-140 mg/l, 140-160 mg/l, 160-180 mg/l, and 180-200 mg/l. The TOC of a tea extract may be from 0.1 to 10 mg/kg seed weight, such as from 0.1 to 0.5, 0.5 to 2.5, and 2.5 to 10 mg/kg seed weight.

For treating seeds by applying an aqueous tea extract to seeds and allowing it to dry, the tea extract may also contain 500 to 10,000 mg/l of TOC, such as from 500-1000 mg/l, 1000-2000 mg/l, 2000-3000 mg/l, 3000-4000 mg/l, 4000-5000 mg/l, 5000-6000 mg/l, 7000-8000 mg/l, 8000-9000 mg/l, and 9000-10000 mg/l.

For priming seeds, the tea extract may also contain 500 to 10,000 mg/l of TOC, such as from 500-1000 mg/l, 1000-2000 mg/l, 2000-3000 mg/l, 3000-4000 mg/l, 4000-5000 mg/l, 5000-6000 mg/l, 7000-8000 mg/l, 8000-9000 mg/l, and 9000-10000 mg/l.

For foliar applications, a tea extract may be applied to plant leaves at a total rate from 0.2 to 5 grams of TOC per hectare, such as 0.2 to 0.6, 0.6 to 1.0, 1.0 to 1.5, 1.5 to 2.0, 2.0-2.5, 2.5-3.0, 3.0-3.5, 3.5-4.0, 4.0-4.5, and 4.5-5.0 grams of TOC per hectare. The aqueous spray may contain concentrations of tea extract at TOC levels of 10 to 1000 mg/l, such as 10-100 mg/l, 100-200 mg/l, 200-300 mg/l, 300-400 mg/l, 400-500 mg/l, 500-600 mg/l, 600-700 mg/l, 700-800 mg/l, 800-900 mg/l, and 900-1000 mg/l.

For soil applications, a tea extract may be applied to soil at a total rate from 0.2 to 5 grams of TOC per hectare, such as 0.2 to 0.6, 0.6 to 1.0, 1.0 to 1.5, 1.5 to 2.0, 2.0-2.5, 2.5-3.0, 3.0-3.5, 3.5-4.0, 4.0-4.5, and 4.5-5.0 grams of TOC per hectare. The aqueous spray may contain concentrations of tea extract at TOC levels of 10 to 1000 mg/l, such as 10-100 mg/l, 100-200 mg/l, 200-300 mg/l, 300-400 mg/l, 400-500 mg/l, 500-600 mg/l, 600-700 mg/l, 700-800 mg/l, 800-900 mg/l, and 900-1000 mg/l.

In certain embodiments, the methods for promoting plant growth, health or yield and quality provided herein also comprise treating a portion of a plant with one or more additional plant protection or nutritional compound.

A “plant protection or nutritional compound” is an agent (compound, composition, or microorganism) that promotes plant growth, health or yield, or that protects the plant against weeds, insects or other pathogens. In addition to extracts of oxidized teas provided herein, these include fertilizers, inoculants, biostimulants, and plant protection chemicals.

Fertilizers that may be used in combination with a tea extract according to the methods provided herein include macronutrients (which are used by plants in proportionally larger amounts relative to micronutrients) and/or micronutrients (which are used in smaller amounts relative to macronutrients). Exemplary macronutrients include nitrogen, potassium, phosphorus, calcium, magnesium and sulfur. Exemplary micronutrients include iron, manganese, zinc, copper, boron, molybdenum and cobalt. In certain embodiments, additional plant protection or nutritional components comprise plant micronutrient(s) iron, zinc or both. In certain other embodiments, additional plant protection or nutritional components comprise both macronutrients (e.g., nitrogen, phosphorus and potassium) as well as micronutrients (e.g., iron and zinc). The fertilizer may be in a liquid form or in a solid form.

Inoculants that may be used in combination with a tea extract according to the methods provided herein include various microorganisms with beneficial effects on plants, such as nitrogen-fixing bacteria, phosphate-solubilizing bacteria, fungal inoculants and composite inoculants. Exemplary inoculants include Rhizobium, Bradyrhizobium, Bacillus, Azobacter, Arhrobacter, Pseudomonas, Azospirillium, cyanobacteria, and mycorrihizal fungi.

Inoculants can include bacterial strains Herbaspirillum seropedicae 2A, Pantoea agglomerans P101, Pantoea agglomerans P102, Klebsiella pneumoniae 342, Klebsiella pneumoniae zmvsy, Herbaspirillum seropedicae Z152, Gluconacetobacter diazotrophicus PA15.

Examples of nitrogen-fixing bacteria inoculants include rhizobacteria, for example, Rhizobium japonicum and Bradyrhizobium japanicum and closely related genera. Genetically modified Rhizobium, such as trifolitoxin expressing types, are examples of trans-inoculants.

Certain soil bacteria, such as Gram negative strains including Pantoea agglomerans and related diazotrophs, are useful for stimulating nodulation in legumes and perhaps limit growth of phytopathogenic fungi. Other bacterial strains include Burkholderia cepacia 2J6 (ATCC Accession No. 55982), Burkholderia cepacia AMMD 2358 (ATCC Accession No. 55983) and Azospirillum brasilense SAB MKB having accession number NRRL B-30081. Other examples of soil bacteria include, for example, Bacillus subtilis and Bacillus pumilus (e.g., strain GB34).

Examples of phosphate-solubilizing bacteria include, for example, Agrobacterium radiobacter.

Examples of fungal inoculants include, for example, vesicular-arbuscular mycorrhizae (VAM), arbuscular mycorrhizae (AM), Penicillium bilaii, and endophytic fungi, such as Piriformis indica. Other fungal inoculants can include, for example, members of the Trichoderma genus of fungi characterized as opportunistic avirulent plant symbionts effective against fungal diseases of root surfaces, e.g., the species T. harzianum, T. viride and T. hamatum.

Specific combinations include, for example, Penicillium bilaii and Rhizobium spp (inclusive of Rhizobium genus and Bradyrhizobium genus).

Examples of composite inoculants include, for example, the combination of strains of plant growth promoting Rhizobacteria (PGPR) and arbuscular mycorrhizae, or multiple strain inoculants where only one strain is diazotrophic.

Additional inoculates that may be used as plant growth regulators in combination with extracts of oxidized tea include those disclosed in U.S. Patent Application Publication No. 2012/0015805, which inoculates are incorporated herein by reference.

Legume plants are particularly suitable for use with inoculants as additional plant regulators. Such plants include, but are not limited to grain legumes such as various varieties of beans, lentils, lupins, peanuts, soybean, and peas.

The inoculants can be applied in a liquid composition, for example, physically mixed or blended with an aqueous solution comprising an extract of oxidized tea to result in a formulation suitable for treating portions of plants (e.g., seeds and roots). The inoculants can also be provided in a solid or semi-solid state, which can include a carrier, such as peat, irradiated sedge peat in particular. Additional agents can be used, including for example, adhesion agents, water-insoluble and/or water soluble polymers conventionally used in the dispensing and application of inoculants to seeds.

Plant biostimulants are various substances and materials other than nutrients and plant protection chemicals, when applied to plants, are capable of modifying the physiology of plants, promoting their growth and enhancing their stress response. Plant biostimulants that may be used as additional plant growth regulators include plant hormones, humic substances, complex organic materials, beneficial chemical elements (e.g., Al, Co, Na, Se and Si), sea plant or seaweed extracts, ascorbic acid (and its salts), chitin and chitosan derivatives, free amino acids and other N-containing substances (e.g., peptides, betaines and related substances). Preferably, plant biostimulants used in combination with an oxidized tea extract include ascorbic acid.

Plant hormones include abscisic acid, auxins, cytokinins, ethylene, gibberellins, brassinosteroids, salicylic acid, jasmonates, plant peptide hormones, polyamines, nitric oxide, strigolactones, and karrikins.

Humic substances are natural substances derived from soil organic matter or ancient fossilized soil organic matter like peat, lignite, leonardite or other forms of oxidized coal and resulting from the decomposition of dead cellular materials and from the metabolic activity of soil microbes using these substrates.

Complex organic materials are obtained from composts, manure, sewage sludge extracts, agro-industrial and urban waste products. They can be applied on soil or on plants to increase soil organic matter, to improve physico-chemical characteristics of soil, to provide macro- and micro-nutrients, to promote rhizobacterial activity, nutrient cycling and nutrient use efficiency, to control soil-borne pathogens, to enhance the degradation of pesticide residues and of xenobiotics.

Seaweed extracts are extracts from seaweeds that belong to a vast group of species and are classified into different phylums, including brown, red and green macroalgae, that promote plant growth, health and/or yield. Exemplary seaweed extracts include Ascophyllum nodosum extract and Ecklonai maxima extract.

Plant protection chemicals that may be used in the methods disclosed herein include herbicides, insecticides, fungicides, bactericides, molluscicides, nematocides, acaricides, anti-microbials, and the like.

Exemplary herbicides include imidazolinone, sulfonylurea, glyphosate, glufosinate, L-phosphinothricin, triazine, benzonitrile, Dicamba (3,6-dichloro-o-anisic acid or 3,6-dichloro-2-methoxybenzoic acid), the active ingredient in herbicides such as BANVEL™ (BASF), CLARITY™ (BASF), and VANQUISH™ (Syngenta), pyrethrins and synthetic pyrethroids; azoles, oxadizine derivatives; chloronicotinyls; nitroguanidine derivatives; triazoles; organophosphates; pyrrols; pyrazoles; phenyl pyrazoles; diacylhydrazines; and carbamates. Examples of herbicides within some of the above-listed categories are in The Pesticide Manual, 12th Ed., C. D. S. Tomlin, Ed., British Crop Protection Council, Farnham, Surry, UK (2000), which herbicides are incorporated by reference.

Exemplary insecticides include organochlorines, organophosphates, carbamates, neonicotinoids (e.g., oxadiazine derivative insecticides, chloronicotinyl insecticides, and nitroguanidine insecticides), phenylpyrazoles, and pyrethroids, such as tefluthrin, terbufos, cypermethrin, thiodicarb, lindane, furathiocarb, acephate, butocarboxim, carbofuran, NTN, endosulfan, fipronil, diethion, aldoxycarb, methiocarb, oftanol, (isofenphos), chlorpyrifos, bendiocarb, benfuracarb, oxamyl, parathion, capfos, dimethoate, fonofos, chlorfenvinphos, cartap, fenthion, fenitrothion, HCH, deltamethrin, malathion, disulfoton, clothianidin, and combinations thereof.

Exemplary fungicides include Mefenoxam & Fludioxonil (ApronMaxx RTA, Syngenta USA), tebuconazole, simeconazole, fluquinconazole, difenoconazole, 4,5-dimethyl-N-(2-propenyl)-2-(trimethylsilyl)-3-thiophenecarboxamide (silthiopham), hexaconazole, etaconazole, propiconazole, triticonazole, flutriafol, epoxiconazole, fenbuconazole, bromuconazole, penconazole, imazalil, tetraconazole, flusilazole, metconazole, diniconazole, myclobutanil, triadimenol, bitertanol, pyremethanil, cyprodinil, tridemorph, fenpropimorph, kresoxim-methyl, azoxystrobin, ZEN90160, fenpiclonil, benalaxyl, furalaxyl, metalaxyl, R-metalaxyl, orfurace, oxadixyl, carboxin, prochloraz, trifulmizole, pyrifenox, acibenzolar-5-methyl, chlorothalonil, cymoaxnil, dimethomorph, famoxadone, quinoxyfen, fenpropidine, spiroxamine, triazoxide, BAS50001 F, hymexazole, pencycuron, fenamidone, guazatine, and cyproconazole.

Exemplary anti-microbials include vanillin, thymol, eugenol, citral, carbacrol, biphenyl, phenyl hydroquinone, Na-o-phenylphenol, thiabendazole, K-sorbate, Na-benzoate, trihydroxybutylphenone, and propylparaben.

Additional plant protection chemicals may be found in U.S. Patent Application Publication Nos. 2004/0023802, 2005/0148470, 2008/0125319, and 2012/0015805, which chemicals are incorporated herein by reference.

Plant protection or nutritional components include those disclosed in the examples provided herein, such as Releaf, urea fertilizer, Precede, Ascend, Ecolicitor, Kelpak, and Acadian.

The additional plant protection or nutritional component(s) may be applied to at least a portion of a plant before, concurrently, or after the application of an extract of oxidized tea to at least the portion of the plant. For concurrent applications of a tea extract and one or more additional plant protection or nutritional components, the tea extract and the additional component(s) may be applied together by first mixing the tea extract and the additional component(s) to form a composition or mixture of the extract and the additional component(s). Alternatively, they may be applied separately, that is, the tea extract and the additional component(s) are not mixed before their applications.

In another aspect, the present disclosure provides compositions that comprise (i) extracts of oxidized tea, and (ii) one or more additional plant protection or nutritional components other than carrageenan or ascorbic acid. In certain embodiments, the compositions comprise (i) extracts of oxidized tea, and (ii) one or more additional plant protection or nutritional components other than a seaweed extract or ascorbic acid.

As described below, the compositions may further comprise carrageenan as a stabilizer and/or ascorbic acid as either a stabilizer or a seed priming agent. However, in such a case, in addition to an extract of oxidized tea as well as carrageenan and/or ascorbic acid, the composition also comprises one or more additional plant protection or nutritional components (e.g., fertilizers, inoculants, and plant protection chemicals).

The compositions comprising extracts of oxidized tea and one or more additional plant protection or nutritional components may be in a liquid form. For example, both a tea extract and one or more additional components may be in a liquid form. Mixing them together will produce a composition also in a liquid form. In some embodiments, the tea extract is in a liquid form, and the additional component(s) in a solid form may be dissolved or suspended in the tea extract. In certain other embodiments, the additional component(s) is in a liquid form, and the tea extract in a solid form is dissolved or suspended in the solution that contains the additional component(s).

Alternatively, the compositions comprising extracts of oxidized tea and one or more additional plant protection or nutritional components may be in a solid form. For example, both tea extracts and additional components may be in a solid form. They may be fixed together to form a composition in a solid form that comprises both tea extract and the additional component(s). In some embodiments, the additional component(s) (e.g., fertilizers) may be in a solid form (e.g., as dry granules), and the tea extract is in a liquid form. The tea extract may be sprayed onto the additional component(s) to form a coating on the additional component(s) (e.g., fertilizer granules coated with tea extract). In certain other embodiments, the tea extract may be in a solid form while the additional component(s) is in a liquid form. Mixing the tea extract with the additional component(s) and subsequently drying the mixture forms a composition in a solid form that comprises both components.

The ratio of tea extract to additional plant protection or nutritional component(s) varies depending on the tea extract (e.g., the amount of thearubigins in the tea extract) and the additional component(s). It is within the scope of ordinary skill to determine or adjust such a ratio so that when the composition is applied to a portion of a plant or a whole plant, the tea extract and the additional component(s) are each in an amount effective in promoting plant growth, health or yield.

The compositions provided herein may further comprise (iii) a preservative that prevent bacterial, yeast or fungal growth and extend the shelf life of the compositions. Exemplary preservatives include potassium sorbate, citric acid, sodium benzoate, and methyl paraben.

The compositions provided herein may also comprise (iv) a stabilizer to reduce the formation of precipitates from the extracts at cold temperatures. Exemplary stabilizers includes ascorbic acid (or its salts), carrageenan, AQUALON™, BONDWELL™ and BLANOSE™ cellulose gum (Ashland Inc., Covington, Ky.), and SUPERCOL™ guar gum (Ashland Inc., Covington, Ky.).

The compositions provided herein may also comprise (v) a seed priming agent. Exemplary seed priming agents include chitosan, polyethylene glycol (PEG), and ascorbic acid.

As used herein, “a composition comprising a given number of components” refers to a composition that comprises at least the given number of different components. In other words, no component in the composition may be deemed as two or more components unless otherwise explicitly provided even if one component in the composition may function as two or more components. For example, although ascorbic acid may function as both a stabilizer and a seed priming agent, a composition comprising both a stabilizer and a seed priming agent as used herein does not include a composition that only comprises ascorbic acid as both a stabilizer and a seed priming agent. Unless otherwise explicitly provided, in addition to ascorbic acid, the composition also comprises another stabilizer (if ascorbic acid is used as a stabilizer) or another seed priming agent (if ascorbic acid is used as a seed priming agent).

In a related aspect, the present disclosure provides an extract of oxidized tea or a composition that comprises an extract of oxidized tea as provided herein for use in promoting plant growth, health or yield, including priming seeds. The composition may further comprise one or more additional plant protection or nutritional components, preservatives, stabilizers, seed priming agents, or combinations thereof as provided herein. In certain embodiments, the additional plant protection or nutritional component is a seaweed extract or ascorbic acid. In other embodiments, the additional plant protection or nutritional component is not carrageenan, seaweed extract, or ascorbic acid.

In another related aspect, the present disclosure provides use of an extract of oxidized tea or a composition that comprises an extract of oxidized tea as provided herein in promoting plant growth, health or yield, including priming seeds. The composition may further comprise one or more additional plant protection or nutritional components, preservatives, stabilizers, seed priming agents, or combinations thereof as provided herein. In certain embodiments, the additional plant protection or nutritional component is a seaweed extract or ascorbic acid. In other embodiments, the additional plant protection or nutritional component is not seaweed extract or ascorbic acid.

In another aspect, the present disclosure provides a seed composition that comprises a seed and an extract of oxidized tea. The seed composition may be produced as described above for treating the seeds with the tea extract (e.g., by applying the tea extract to seeds and subsequently allowing it to dry, by priming seeds, or by “seed soak”). Any standard seed treatment methodology, including but are not limited to mixing tea extract and seeds in a container, mechanical application, tumbling, spraying and immersion may be used to apply the tea extract to the seeds.

In certain embodiments, the seed composition is a seed primed with an oxidized tea extract or a composition that comprises an oxidized tea extract. Seed priming methods known in the art may be used or modified to prime seed with an oxidized tea extract, such as those described in Guan et al., Journal of Zhejiang University Science B 10(6):427-33, 2009; Chen and Arora, Plant Science 180:212-20, 2011; Farooq et al., Journal of Agronomy and Crop Science 199:12-22, 2013. The composition that comprises an oxidized tea extract may further comprise one or more additional seed priming agents, such as chitosan, polyethylene glycol (PEG), and ascorbic acid.

In certain embodiments, the seed composition is a seed coated with an oxidized tea extract. Seed coating methods known in the art may be used or modified to coat seeds with an oxidized tea extract, such as those described in U.S. Pat. Nos. 5,918,413, 5,891,246, 5,554,445, and U.S. Patent Application Publication Nos. 2004/0023802 and 2005/0148470, which methods are incorporated herein by reference.

Seeds coated with an oxidized tea extract may also comprise other inactive ingredients to facilitate the coating of seeds with the oxidized tea extract, such as binders. Such binders preferably comprise an adhesive polymer that may be natural or synthetic and are not phytotoxic to the seeds to be coated. The binder may be selected from polyvinyl acetates; polyvinyl acetate copolymers; ethylene vinyl acetate (EVA) copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyrolidones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, methylacrylamide monomers; and polychloroprene.

Seeds coated with an oxidized tea extract may also comprise a filler as another inactive ingredient. The filler may include woodflours, clays and fine-grain inorganic solids (e.g., calcium bentonite, kaolin, china clay, talc, perlite, mica, vermiculite, silicas, quartz powder, montmorillonite and mixtures thereof), activated carbon, sugars (e.g., dextrin and maltodextrin), diatomaceous earth, cereal flours (e.g., wheat flour, oat flour and barley flour), calcium carbonate, and the like.

Seeds coated with an oxidized tea extract may also comprise a plasticizer as another inactive ingredient. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Exemplary plasticizers include polyethylene glycol, glycerol, butylbenzylphthalate, glycol benzoates and related compounds.

In certain embodiments, seed compositions further comprise one or more additional plant protection or nutritional components, preservatives, stabilizers, seed priming agents, or combinations thereof as described herein. In certain embodiments, the additional plant protection or nutritional component is a seaweed extract (including carrageenan) or ascorbic acid. In other embodiments, the additional plant protection or nutritional component is not carrageenan, seaweed extract, or ascorbic acid. The additional plant protection or nutritional component(s), preservatives, stabilizers, and/or seed priming agents may be applied to the seeds together with the tea extract (e.g., by first mixing the tea extract and the additional component(s), preservative(s), stabilizer(s), and/or seed priming agent(s) to form a mixture), or separately from the application of the tea extract (e.g., either before or after the application of the tea extract). Preferably, preservatives, stabilizers, and/or seed priming agents are first mixed with oxidized tea extracts and then applied to the seeds. In the embodiments where the seed composition comprises ascorbic acid in addition to an oxidized tea extract and a seed, ascorbic acid may function as a biostimulant, a seed priming agent, and/or a preservative.

In certain embodiments, the seed composition may further comprise a film-coating material, such as Sepiret (Seppic, Inc. Fairfield, N.J.) and Opacoat (Berwind Pharm. Services, Westpoint, Pa.) that forms a second coating on a seed that is already coated with a tea extract or a composition that comprises a tea extract, optionally one or more additional plant protection or nutritional components, and optionally one or more inactive ingredients.

The following examples are for illustration and are not limiting.

### Example 1

### Preparation of Tea Extracts

To study the effect of tea extracts on plant growth a wide range of commercial teas were purchased from a supermarket. In each case the contents of the individual tea bags were carefully weighed out so that 20 grams of material was extracted in 200 ml of mineral water at 95 degrees C. for 120 minutes. The resulting solutions were kept in the refrigerator at 4 degrees C. for preservation during the course of the studies. New solutions were prepared each month.

The solutions were analyzed at the University of Washington laboratory for total carbon (TC), total organic carbon (TOC) and total nitrogen (N). Results of this analysis are shown in the table below for Yellow label tea and for Darjeeling Tea.

### Total Carbon and Nitrogen Contents of Black Tea Extracts

| | | | Total | Total | TOC after |
|---|---|---|---|---|---|
| Sample | Total C | TOC | inor. C | N | centrofuge |
| ID | mg/L | mg/L | mg/L | mg/L | mg/L |
| Darjeeling Tea | 3511 | 3400 | 111 | 290 | 3287 |
| Yellow Label Tea | 4141 | 3896 | 245 | 400 | 3087 |

### Example 2

### Study of Polyphenolic Extracts on Wheat Under Normal Temperature

### Abstract

Three polyphenol rich compounds were tested as a seed treatment on wheat. These three polyphenol rich compounds included: 1) humic substances extracted from natural organic matter (HSN), 2) water-extractable polyphenols from strongly oxidized leaves of Camellia sinensis (OLC), and 3) water-extractable polyphenols from slightly oxidized leaves of Camellia s. (NOL). Effects on wheat germination and subsequent seedling biomass production were studied in growth chambers. The independent addition, separately, of HSN and OLC, both significantly increased the speed of germination throughout the duration of the experiment. At 72 hours OLC and HSN significantly accelerated wheat germination and were, respectively, significantly better by 187% than the untreated control. This increase persisted throughout the duration of the experiment and at 96, 130 and at 154 hours, OLC treated seeds were statistically better than the grower standard control by 67.9%, 41.1% and by 29.3% respectively.

At 9 days after the initial watering, water-extractable polyphenols from strongly oxidized leaves of Camellia sinensis (OLC) and HSN showed statistically significant increases in seedling biomass production as measured by total plant fresh weight. Concerning total plant fresh weight (g per tray) OLC and HSN were significantly better than the grower standard control by 67.1% and by 43.6%, respectively. With respect to the fresh shoot weight OLC and HSN were statistically better than the control by 59.0% and by 37.69% respectively. Finally, with regard to fresh root weight, the same treatments OLC and the humic substance were significantly better than the grower standard control by 77.8% and by 51.2%, respectively.

The extract of barely oxidized leaves of Camellia s. (NOL) was no better than the control in germination, and was significantly worse than the control in plant biomass production as measured by total fresh plant weight and with regard to root and shoot weight.

This experiment indicates that compounds produced during the oxidation of Camellia sinensis enhance germination rates much more than those found in the Camellia sinensis leaves before being “fermented” or oxidized.

### Material and Method

Two kinds of teas were purchased from a supermarket. A green tea was purchased and a black tea (Lipton Red Label). A water extract of each was made by the simple method of steeping the tea bags in hot tap water for 15 minutes. A sample of humic substances from natural organic matter (HSN) known to be an effective seed treatment was also obtained. Each sample was analyzed for total organic carbon (TOC) at a certified laboratory using standard procedures for dissolved organic carbon.

Commercial spring wheat seeds from Canada were carefully treated using the three different polyphenol rich solutions at controlled dilutions. In each case, 200 grams of seed were measure into a 15 cm×10 cm×3 cm plastic tray. An equivalent volume of pure water was applied to all of the treatments including the control in order to avoid unintended effects from priming of the seeds. Afterward they were air dried in the ambient air of the laboratory at 20 degrees C.

Seeds were symmetrically placed, following a planting pattern of 6×5, on top of a plain white paper towel which was placed on top of a sponge. The sponges were located inside individual transparent plastic containers in order to maintain constant water content within the sponge and across the surface of the paper towels. The process of germination was followed using germination criteria set by the International Seed Association guidelines to measure the progression of the studied seeds. Observations were made once every 24 hours.

Treatments were arranged in 5 randomized complete blocks and the data were statistically analyzed using the Analysis of Variance test (ANOVA). When the ANOVA test highlighted significant statistically differences, the Duncan's new multiple range test (MRT) was applied to identify mean separations of each of the treatments.

### Results

Polyphenolic Extract from Oxidized Leaves of Camellia sinensis on Wheat: Germination at 72 Hours

| Treatment | Description | B1 | B2 | B3 | B4 | B5 | Average |
|---|---|---|---|---|---|---|---|
| T1 | Control | 5 | 1 | 9 | 5 | 10 | 6.0 c |
| T2 | OLC | 16 | 17 | 16 | 19 | 18 | 17.2 a |
| T3 | HSN | 19 | 19 | 14 | 17 | 16 | 17.0 a |
| T4 | NOL | 8 | 12 | 15 | 6 | 15 | 11.2 b |

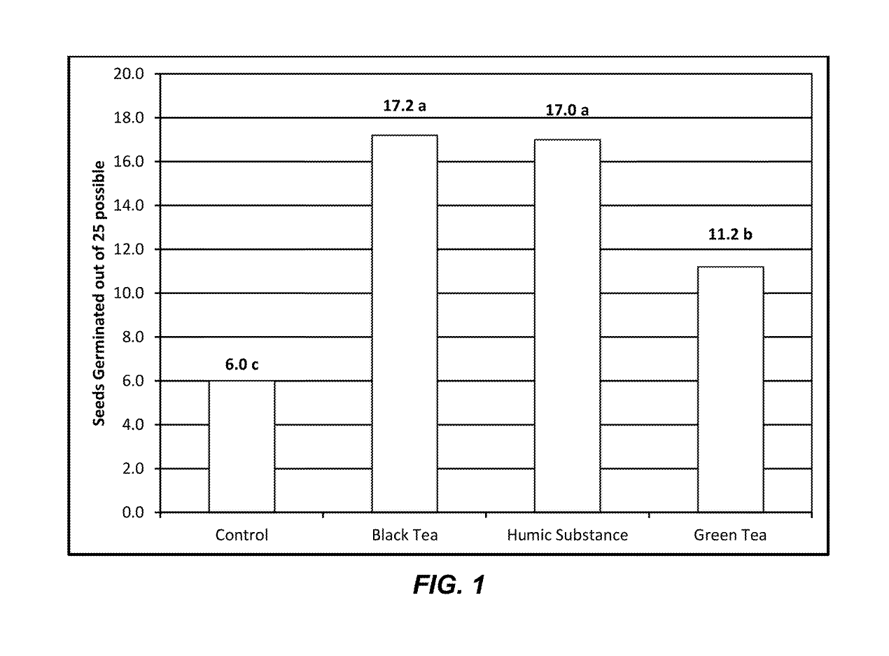

The Duncan Test at a 5% level of probability was applied. The averages followed by the same letter do not differ statistically among themselves. The results are also presented in FIG. 1.

Polyphenolic Extract from Oxidized Leaves of Camellia sinensis on Wheat: Germination at 96 Hours

| Treatment | Description | B1 | B2 | B3 | B4 | B5 | Average |
|---|---|---|---|---|---|---|---|
| T1 | Control | 10 | 5 | 13 | 12 | 16 | 11.2 b |
| T2 | OLC | 16 | 18 | 16 | 22 | 22 | 18.8 a |
| T3 | HSN | 20 | 19 | 14 | 24 | 20 | 19.4 a |
| T4 | NOL | 10 | 15 | 16 | 10 | 19 | 14.0 b |

The Duncan Test at a 5% level of probability was applied. The averages followed by the same letter do not differ statistically among themselves.

Polyphenolic Extract from Oxidized Leaves of Camellia sinensis on Wheat: Germination at 130 Hours

| Treatment | Description | B1 | B2 | B3 | B4 | B5 | Average |
|---|---|---|---|---|---|---|---|
| T1 | Control | 14 | 10 | 17 | 14 | 18 | 14.6 ns |
| T2 | OLC | 18 | 20 | 19 | 23 | 23 | 20.6 ns |
| T3 | HSN | 20 | 20 | 16 | 24 | 23 | 20.6 ns |
| T4 | NOL | 12 | 17 | 18 | 12 | 22 | 16.2 ns |

ns: Not Significant (p > = .05)

Polyphenolic Extract from Oxidized Leaves of Camellia sinensis on Wheat: Germination at 154 Hours

| Treatment | Description | B1 | B2 | B3 | B4 | B5 | Average |
|---|---|---|---|---|---|---|---|
| T1 | Control | 15 | 12 | 17 | 16 | 22 | 16.4 b |
| T2 | OLC | 18 | 21 | 21 | 23 | 23 | 21.2 a |
| T3 | HSN | 20 | 20 | 16 | 24 | 23 | 20.6 a |
| T4 | NOL | 12 | 17 | 18 | 11 | 22 | 16.0 b |

The Duncan Test at a 5% level of probability was applied. The averages followed by the same letter do not differ statistically among themselves.

### Seedling Biomass Production Measured as Fresh Weights on Day 9

a. Polyphenolic Extract from Oxidized Leaves of Camellia sinensis on Wheat: Shoot Weight (g Per Tray)

| Treatment | Description | B1 | B2 | B3 | B4 | Average |
|---|---|---|---|---|---|---|
| T1 | Control | 0.62 | 0.93 | 0.82 | 0.92 | 0.82 b |
| T2 | OLC | 1.35 | 0.81 | 1.44 | 1.63 | 1.31 a |
| T3 | HSN | 1.11 | 0.88 | 1.18 | 1.36 | 1.13 ab |
| T4 | NOL | 0.26 | 0.41 | 0.62 | 0.10 | 0.35 c |

The Duncan Test at a 5% level of probability was applied. The averages followed by the same letter do not differ statistically among themselves.

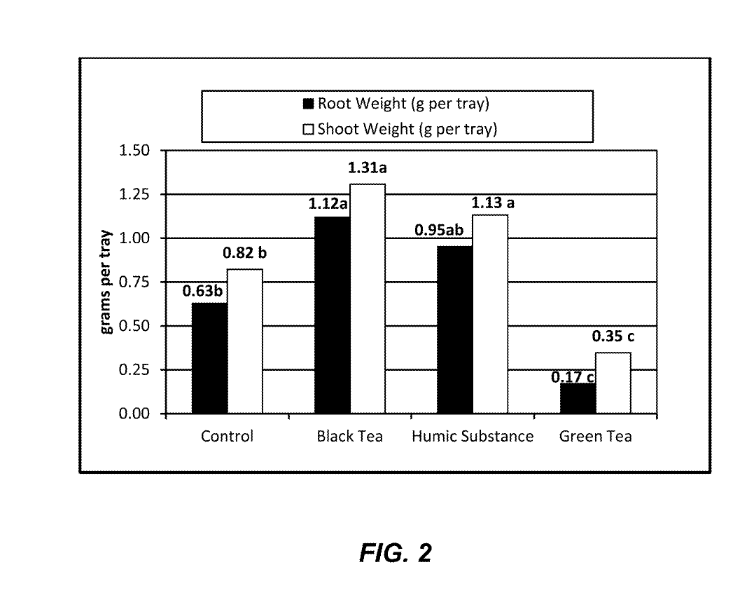

The results are also shown in FIG. 2.

b. Polyphenolic Extract from Oxidized Leaves of Camellia sinensis on Wheat: Root Weight (g per Tray)

| Treatment | Description | B1 | B2 | B3 | B4 | Average |
|---|---|---|---|---|---|---|
| T1 | Control | 0.46 | 0.68 | 0.62 | 0.76 | 0.63 b |
| T2 | OLC | 1.31 | 0.62 | 1.38 | 1.17 | 1.12 a |
| T3 | HSN | 1.03 | 0.65 | 1.15 | 0.98 | 0.95 a |
| T4 | NOL | 0.17 | 0.12 | 0.30 | 0.10 | 0.17 c |

The Duncan Test at a 5% level of probability was applied. The averages followed by the same letter do not differ statistically among themselves.

The results are also shown in FIG. 2.

c. Polyphenolic Extract from Oxidized Leaves of Camellia sinensis on Wheat: Total Fresh Weight (g Per Tray)

| Treatment | Description | B1 | B2 | B3 | B4 | Average |
|---|---|---|---|---|---|---|
| T1 | Control | 1.08 | 1.61 | 1.44 | 1.68 | 1.45 b |
| T2 | OLC | 2.66 | 1.43 | 2.82 | 2.80 | 2.43 a |
| T3 | HSN | 2.14 | 1.53 | 2.33 | 2.34 | 2.09 ab |
| T4 | NOL | 0.43 | 0.53 | 0.92 | 0.20 | 0.52 c |

The Duncan Test at a 5% level of probability was applied. The averages followed by the same letter do not differ statistically among themselves.

### Conclusion

Water-extractable polyphenols obtained from Camellia sinensis strongly oxidized leaves (OLC) significantly and dramatically enhanced the rate of germination of wheat seeds at optimum temperatures. They also significantly and dramatically enhanced early root and shoot development as measured by fresh weights of roots and shoots. These increases in germination and early growth rates were numerically superior but statistically equivalent to the humic substance from HSN.

Water-extractable polyphenols from slightly oxidized Camellia sinensis leaves (NOL) was numerically better for germination, but was not significantly better than the control. Subsequent seedling growth as measured by fresh weights of roots and shoots were significantly worse than for the control.

It appears that polyphenols produced by enzymatic oxidation of Camellia s. catechins during the mechanical crushing and subsequent oxidation process which takes place for production of black tea adds value in terms of beneficial effects on germination and early root and shoot growth.

### Example 3

### Effects of Water Extracts of Different Varieties of Black Tea on Germination of Wheat

### Abstract

Seven different commercial black teas (strongly oxidized leaves of Camellia sinensis) were extracted with water and used to treat wheat seeds. Effects on wheat germination and subsequent seedling biomass production were studied in growth chambers. All seven of the black teas significantly enhanced the rate of germination and significantly improved final germination percent when compared to a mineral water control. There were slight numeric differences among the different teas, but all of them were statistically equal in their promotion of germination rate and final potential percentage.

This experiment indicates that a wide range of different kinds of black tea can be used to promote faster germination and enhanced germination potential.

### Material and Method

Seven kinds of teas were purchased from a supermarket. These teas are shown in Table A. A water extract of each was made by the simple method of steeping the tea bags in hot tap water for 15 minutes. The teas were all diluted to the same concentration based upon color and upon absorbance at 380 nm on a UV/Vis spectrophotometer.

### List of Six Commercial Teas Used for the Treatments

Treatment Description

T1: Mineral Water (Untreated Control)
T2: English breakfast Tea (Tetley)
T3: Decafeinated Lipton Tea
T4: Darjeeling (Twinings; Doux/Hild)
T5: Tea of Ceylan (Twinings; Sélection exceptionnelle “Scotland”)
T6: Yellow Label Tea (Lipton)
T7: English breakfast Tea (Twinings)

Commercial spring wheat seeds from Canada were carefully treated using each of the seven tea extracts at controlled dilutions. In each case, 200 grams of seed were measure into a 15 cm×10 cm×3 cm plastic tray. An equivalent volume of Crystaline brand mineral water was applied to all of the treatments including the control in order to avoid unintended effects from priming of the seeds. Afterward they were air dried in the ambient air of the laboratory at 20 degrees C.

Seeds were symmetrically placed, following a planting pattern of 6×5, on top of a plain white paper towel which was placed on top of a sponge. The sponges were located inside individual transparent plastic containers in order to maintain constant water content within the sponge and across the surface of the paper towels. The process of germination was followed using germination criteria set by the International Seed Association guidelines to measure the progression of the studied seeds. Observations were made once every 24 hours.

Treatments were arranged in 5 randomized complete blocks and the data were statistically analyzed using the Analysis of Variance test (ANOVA). When the ANOVA test highlighted significant statistically differences, the Duncan's new multiple range test (MRT) was applied in order to identify look at mean separations of each of the treatments.

### Results

### Number of Seeds Germinated (Out of 30 Possible) at 30 Hours:

| Treatment Description | B1 | B2 | B3 | B4 | B5 | Average |
|---|---|---|---|---|---|---|
| T1: Mineral Water (Untreated Control) | 1 | 2 | 2 | 2 | 4 | 2.2 a |
| T2: English breakfast Tea (Tetley) | 5 | 14 | 6 | 7 | 6 | 7.6 b |
| T3: Decafeinated Lipton Tea | 4 | 5 | 2 | 7 | 13 | 6.2 ab |
| T4: Darjeeling (Twinings; Doux/Hild) | 6 | 7 | 10 | 16 | 10 | 9.8 b |
| T5: Tea of Ceylan (Twinings; | 2 | 5 | 6 | 10 | 5 | 5.6 ab |
| Sélection exceptionnelle “Scotland”) | | | | | | |
| T6: Yellow Label Tea (Lipton) | 4 | 12 | 11 | 7 | 12 | 9.2 b |
| T7: English breakfast Tea (Twinings) | 2 | 4 | 8 | 14 | 7 | 7.0 b |

### Number of Seeds Germinated (Out of 30 Possible) at 54 Hours:

| Treatment | | | | | | | |
|---|---|---|---|---|---|---|---|
| Description | B1 | B2 | B3 | B4 | B5 | Average | DMR |
| T1: Mineral Water | 1 | 3 | 3 | 2 | 5 | 2.8 | b |
| (Untreated Control) | | | | | | | |
| T2: English breakfast Tea | 6 | 14 | 7 | 10 | 8 | 9.0 | a |
| (Tetley) | | | | | | | |
| T3: Decafeinated Lipton | 5 | 7 | 2 | 8 | 16 | 7.6 | a |
| Tea | | | | | | | |
| T4: Darjeeling (Twinings; | 7 | 7 | 10 | 16 | 11 | 10.2 | a |
| Doux/Hild) | | | | | | | |
| T5: Tea of Ceylan | 3 | 7 | 7 | 12 | 7 | 7.2 | a |
| (Twinings; Sélection | | | | | | | |
| exceptionnelle “Scotland”) | | | | | | | |
| T6: Yellow Label Tea | 5 | 12 | 12 | 7 | 12 | 9.6 | a |
| (Lipton) | | | | | | | |
| T7: English breakfast Tea | 2 | 4 | 11 | 15 | 11 | 8.6 | a |
| (Twinings) | | | | | | | |

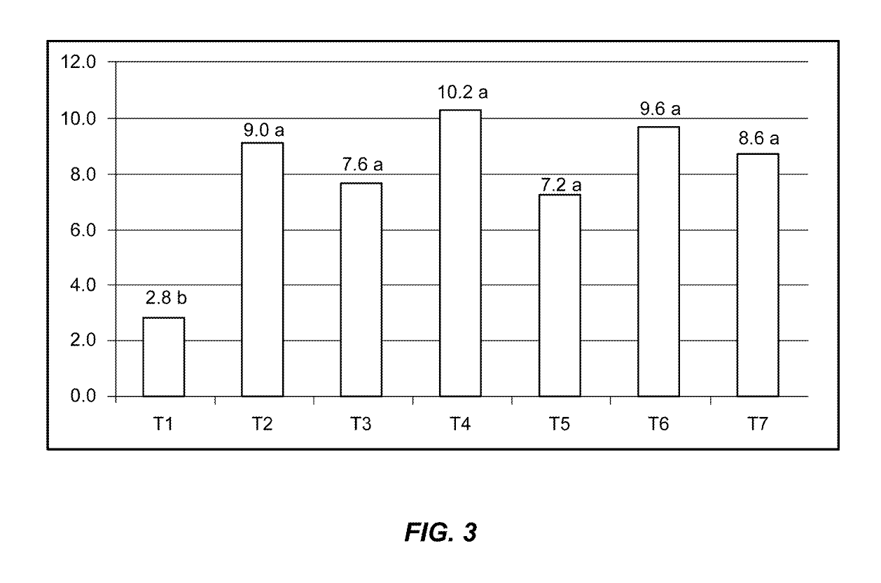

The results are also shown in FIG. 3.

### Number of Seeds Germinated (Out of 30 Possible) at 294 Hours:

| Treatment Description | B1 | B2 | B3 | B4 | B5 | Average | Duncan |
|---|---|---|---|---|---|---|---|
| T1: Mineral Water | 1 | 3 | 3 | 3 | 5 | 3.0 | b |
| (Untreated Control) | | | | | | | |
| T2: English breakfast Tea | 6 | 14 | 9 | 10 | 9 | 9.6 | a |
| (Tetley) | | | | | | | |
| T3: Decafeinated Lipton | 5 | 8 | 2 | 11 | 16 | 8.4 | a |
| Tea | | | | | | | |
| T4: Darjeeling (Twinings; | 8 | 9 | 13 | 21 | 11 | 12.4 | a |
| Doux/Hild) | | | | | | | |
| T5: Tea of Ceylan | 6 | 8 | 9 | 14 | 9 | 9.2 | a |
| (Twinings; Sélection | | | | | | | |
| exceptionnelle “Scotland”) | | | | | | | |
| T6: Yellow Label Tea | 5 | 13 | 13 | 10 | 15 | 11.2 | a |
| (Lipton) | | | | | | | |
| T7: English breakfast Tea | 3 | 4 | 12 | 15 | 13 | 9.4 | a |
| (Twinings) | | | | | | | |

### Conclusion

All seven of the extracts from a wide range of commercial teas significantly improved the rate and final percentage of seeds germinated. There were some numeric differences among the teas, but at no point in the studies were these differences statistically significant.

### Example 4

### Rate Study for an Extract of Black Tea on Germination and Early Growth of Wheat

### Abstract

Leaves of a popular commercial black tea (Lipton Yellow Label) were extracted with water and used to treat wheat seeds at various rates. Effects on wheat germination and subsequent seedling biomass production were studied in growth chambers. All rates were seen to significantly enhance the rate of germination and resulted in significantly greater root and shoot fresh weights. They also significantly increased the root to shoot ratio. The lowest rates were superior in response to higher rates.

### Material and Method

Lipton yellow label tea purchased from a supermarket. A tea extract was made by steeping 20 grams of tea leaves from tea bags in heated mineral water at 95° C. for 120 minutes. The extract had 3,896 mg/l of total organic carbon (TOC).

The original solution was diluted in Crystaline brand mineral water at the following volume based percentage of the final solution: 0.3%, 0.75%, 1.5% and 3.0%.

Commercial spring wheat seeds from Canada were carefully treated using each of the solutions. In each case, 30 grams of seed were measure into a 15 cm×10 cm×3 cm plastic tray. An equivalent volume of 1.2 ml of the solutions was applied to each of the treatments. The same volume of mineral water was applied to the control in order to avoid unintended effects from priming of the seeds. Afterward they were air dried in the ambient air of the laboratory at 20 degrees C.

Seeds were symmetrically placed, following a planting pattern of 6×5, on top of a plain white paper towel which was placed on top of a sponge. The sponges were located inside individual transparent plastic containers in order to maintain constant water content within the sponge and across the surface of the paper towels. The process of germination was followed using germination criteria set by the International Seed Association guidelines to measure the progression of the studied seeds. Observations were made once every 24 hours.

Treatments were arranged in 5 randomized complete blocks and the data were statistically analyzed using the Analysis of Variance test (ANOVA). When the ANOVA test highlighted significant statistically differences, the Duncan's new multiple range test (MRT) was applied in order to identify look at mean separations of each of the treatments.

### Results

### Number of Seeds Germinated (Out of 30 Possible) at 12 Hours:

| Treatment Description | B1 | B2 | B3 | B4 | B5 | Average |
|---|---|---|---|---|---|---|
| T0: Mineral Water | 4 | 2 | 5 | 2 | 2 | 3.0 d |
| (Untreated Control) | | | | | | |
| T1: Tea Extract | 10 | 9 | 11 | 11 | 10 | 10.2 b |
| 0.3% V/V | | | | | | |
| T2: Tea Extract | 10 | 11 | 14 | 13 | 16 | 12.8 a |
| 0.75% V/V | | | | | | |
| T3: Tea Extract | 13 | 14 | 11 | 12 | 15 | 13.0 a |
| 1.5% V/V | | | | | | |
| T4: Tea Extract | 8 | 9 | 8 | 7 | 8 | 8.0 c |
| 3.0% V/V | | | | | | |

### Number of Seeds Germinated (Out of 30 Possible) at 24 Hours:

| Treatment Description | B1 | B2 | B3 | B4 | B5 | Average |
|---|---|---|---|---|---|---|
| T0: Mineral Water | 12 | 4 | 11 | 2 | 4 | 6.6 c |
| (UTC) | | | | | | |
| T1: Tea Extract | 25 | 20 | 27 | 26 | 24 | 24.4 a |
| 0.3% V/V | | | | | | |
| T2: Tea Extract | 20 | 24 | 25 | 24 | 24 | 23.4 a |
| 0.75% V/V | | | | | | |
| T3: Tea Extract | 20 | 25 | 24 | 25 | 25 | 23.8 a |
| 1.5% V/V | | | | | | |
| T4: Tea Extract | 20 | 17 | 19 | 11 | 17 | 16.8 b |
| 3.0% V/V | | | | | | |

### Number of Seeds Germinated (Out of 30 Possible) at 48 Hours:

| Treatment Description | B1 | B2 | B3 | B4 | B5 | Average |
|---|---|---|---|---|---|---|
| T0: Mineral Water | 14 | 11 | 15 | 2 | 5 | 9.4 c |
| (UTC) | | | | | | |
| T1: Tea Extract | 28 | 23 | 29 | 27 | 27 | 26.8 a |
| 0.3% V/V | | | | | | |
| T2: Tea Extract | 20 | 24 | 25 | 26 | 26 | 24.2 a |
| 0.75% V/V | | | | | | |
| T3: Tea Extract | 22 | 26 | 26 | 25 | 26 | 25.0 a |
| 1.5% V/V | | | | | | |
| T4: Tea Extract | 20 | 19 | 25 | 13 | 19 | 19.2 b |
| 3.0% V/V | | | | | | |

### Number of Seeds Germinated (Out of 30 Possible) at 120 Hours:

| Treatment Description | B1 | B2 | B3 | B4 | B5 | Average |
|---|---|---|---|---|---|---|
| T0: Mineral Water | 19 | 21 | 18 | 11 | 6 | 15.0 c |
| (UTC) | | | | | | |
| T1: Tea Extract | 30 | 28 | 30 | 30 | 29 | 29.4 a |
| 0.3% V/V | | | | | | |
| T2: Tea Extract | 25 | 27 | 27 | 29 | 27 | 27.0 ab |
| 0.75% V/V | | | | | | |
| T3: Tea Extract | 27 | 29 | 28 | 28 | 27 | 27.8 ab |
| 1.5% V/V | | | | | | |
| T4 : Tea Extract | 27 | 26 | 27 | 20 | 21 | 24.2 b |
| 3.0% V/V | | | | | | |

### Fresh Weights of Roots and Shoots at 120 Hours

| | Root | Shoot | | |
|---|---|---|---|---|
| | Weight | Weight | Whole | Root:Shoot |
| | (g) | (g) | Plant (g) | Ratio |
| T0: Mineral Water | 0.69 | 0.58 | 1.26 | 1.19 |
| (UTC) | | | | |
| T1: Tea Extract 0.3% | 4.17 | 2.52 | 6.69 | 1.65 |
| V/V | | | | |
| T2: Tea Extract 0.75% | 2.79 | 2.08 | 4.87 | 1.34 |
| V/V | | | | |
| T3: Tea Extract 1.5% | 2.41 | 1.86 | 4.28 | 1.30 |
| V/V | | | | |
| T3: Tea Extract 3.0% | 2.55 | 1.76 | 4.31 | 1.45 |
| V/V | | | | |

### Conclusion

All rates of Lipton yellow label tea extract significantly improved the speed of germination and increased the fresh weights of roots and shoots. The rate that provided the highest degree of stimulation of germination and early root and shoot weights was 0.3% VN.

### Example 5

### Rate Study for an Extract of Black Tea on Germination and Early Growth of Corn

### Abstract

Leaves of a popular commercial black tea (Lipton Yellow Label) were extracted with water and used to treat corn seeds at various rates. Effects on corn germination and subsequent seedling biomass production were studied in growth chambers. All rates were seen to significantly enhance the rate of germination and resulted in significantly greater root and shoot fresh weights. They also significantly increased the root to shoot ratio. The lowest rates were superior in response to higher rates.

### Material and Method

Lipton yellow label tea purchased from a supermarket. A tea extract was made by steeping 20 grams of tea leaves from tea bags in heated mineral water at 95° C. for 120 minutes. The resulting solution was tested for total organic carbon on a total carbon analyzer at the University of Washington. That solution tested 3,896 mg/l of total organic carbon (TOC).

The original solution was diluted in Crystaline brand mineral water at the following volume based percentage of the final solution: 0.3%, 0.75%, 1.5% and 3.0%.

Commercial spring corn seeds from Canada were carefully treated using each of the solutions. In each case, 30 grams of seed were measure into a 15 cm×10 cm×3 cm plastic tray. An equivalent volume of 1.2 ml of the solutions were applied to each of the treatments. The same volume of mineral water was applied to the control in order to avoid unintended effects from priming of the seeds. Afterward they were air dried in the ambient air of the laboratory at 20 degrees C.

Seeds were symmetrically placed, following a planting pattern of 6×5, on top of a plain white paper towel which was placed on top of a sponge. The sponges were located inside individual transparent plastic containers in order to maintain constant water content within the sponge and across the surface of the paper towels. The process of germination was followed using germination criteria set by the International Seed Association guidelines to measure the progression of the studied seeds. Observations were made once every 24 hours.

Treatments were arranged in 5 randomized complete blocks and the data were statistically analyzed using the Analysis of Variance test (ANOVA). When the ANOVA test highlighted significant statistically differences, the Duncan's new multiple range test (MRT) was applied in order to identify look at mean separations of each of the treatments.

### Results

Germination was monitored at 24, 48, 72 and 96 hours. Lipton yellow label tea extract treated seeds germinated significantly faster. The greatest differences were seen at 72 hours. The data is shown for the 72 hour observation below:

### Number of Seeds Germinated (Out of 20 Possible) at 72 Hours:

| Treatment Description | B1 | B2 | B3 | B4 | B5 | Average |
|---|---|---|---|---|---|---|
| T0: Mineral Water | 3 | 8 | 13 | 12 | 9 | 9.0 c |
| (UTC) | | | | | | |
| T1: Tea Extract | 8 | 8 | 12 | 11 | 10 | 9.8 bc |
| 0.3% V/V | | | | | | |
| T2: Tea Extract | 12 | 17 | 18 | 12 | 12 | 14.2 a |
| 0.75% V/V | | | | | | |
| T3: Tea Extract | 16 | 14 | 17 | 16 | 19 | 16.4 a |
| 1.5% V/V | | | | | | |
| T4: Tea Extract | 10 | 16 | 16 | 12 | 11 | 13.0 ab |
| 3.0% V/V | | | | | | |

### Root and Shoot Fresh Weight Data at 168 Hours

At 168 hours all seeds possible had germinated. The plants were removed for each tray and the fresh weight of the roots and shoots were measured for each tray.

a. Biomass Production: Shoot Weight at 168 Hours

| Treatment | | | | | | | |
|---|---|---|---|---|---|---|---|
| Description | B1 | B2 | B3 | B4 | B5 | Average | DMR |
| T0: Mineral Water | 0.50 | 0.58 | 1.13 | 0.33 | 0.01 | 0.51 | b |
| (UTC) | | | | | | | |
| T1: Tea Extract | 0.77 | 1.29 | 0.32 | 0.49 | 0.22 | 0.62 | b |
| 0.3% V/V | | | | | | | |
| T2: Tea Extract | 1.44 | 1.57 | 1.07 | 0.34 | 0.32 | 0.95 | b |
| 0.75% V/V | | | | | | | |
| T3: Tea Extract | 1.57 | 2.28 | 1.78 | 1.70 | 1.23 | 1.71 | a |
| 1.5% V/V | | | | | | | |
| T4: Tea Extract | 1.14 | 2.12 | 2.10 | 1.40 | 1.16 | 1.58 | a |
| 3.0% V/V | | | | | | | |

b. Biomass Production: Root Weight at 168 Hours

| Treatment | | | | | | | |
|---|---|---|---|---|---|---|---|
| Description | B1 | B2 | B3 | B4 | B5 | Average | DMR |
| T0: Mineral Water | 2.75 | 4.07 | 2.02 | 3.29 | 0.35 | 2.50 | b |
| (UTC) | | | | | | | |
| T1: Tea Extract | 3.50 | 4.85 | 2.77 | 2.57 | 1.94 | 3.13 | b |
| 0.3% V/V | | | | | | | |
| T2: Tea Extract | 5.16 | 5.98 | 4.69 | 2.76 | 1.46 | 4.01 | b |
| 0.75% V/V | | | | | | | |
| T3: Tea Extract | 6.25 | 6.63 | 6.03 | 6.51 | 5.27 | 6.14 | a |
| 1.5% V/V | | | | | | | |
| T4: Tea Extract | 4.85 | 6.91 | 6.39 | 6.08 | 4.27 | 5.70 | a |
| 3.0% V/V | | | | | | | |

### Conclusion

All rates of the Lipton yellow label tea extract significantly improved the speed of germination and increased the fresh weights of roots and shoots. The rate that provided the highest degree of stimulation of germination and early root and shoot weights was 1.5% VN.

### Example 6

### Effect of Foliage Application of Black Tea Extract in Combination with Releaf on Wheat Root Growth

### Materials and Methods:

A randomized complete block design experiment with 4 replicates was established in wheat (Superb) on a sandy clay loam (30% sand, 30% silt and 40% clay) soil. The field was fertilized according to soil test recommendations. The previous crop was Roundup Ready canola. Plot size was 2 by 8 m.

Lipton yellow label tea extract was prepared by steeping 20 grams of tea leaves from tea bags in heated mineral water at 95° C. for 120 minutes. At the end of the period, the extract reached room temperature. RELEAF™ (a nutritional based product containing macro and trace nutrients: 6-18-5 with 0.1% Zn, Mn and Fe, 0.05% Cu and B) was obtained from ATP Nutrition (Oak Bluff, Manitoba, Canada).

A conventional CO₂ sprayer was employed to apply the treatments shown in the table below to the foliage of the wheat plants. For the root system measurements, the WinRhizo Pro 2012b (Regent Instr. Inc., Quebec, Canada) images analysis system was used, coupled with a professional scanner Epson XL 1000 equipped with additional light unit (TPU) (see, Arsenault et al., HortScience 30:906, 1995). For the images of root measurement the definition of 600 (dpi) was used. The root characteristics were determined as follows: total root length (RL) (cm) and root surface area (SA) (cm²).

| | | | Application |
|---|---|---|---|
| | Treatments | Application rates | Information |
| 1 | UTC | 0 | 2-3 Leaf stage |
| 2 | RELEAF ™ | 5 L/Ha | 2-3 Leaf stage |
| 3 | RELEAF ™ + Tea Extract | 5 L/Ha + 125 mL/Ha | 2-3 Leaf stage |
| 4 | RELEAF ™ + Tea Extract | 5 L/Ha + 250 mL/Ha | 2-3 Leaf stage |
| 5 | RELEAF ™ + Tea Extract | 5 L/Ha + 500 mL/Ha | 2-3 Leaf stage |
| 6 | RELEAF ™ + Tea Extract | 5 L/Ha + 1000 mL/Ha | 2-3 Leaf stage |

### Results:

No phytotoxicity was observed with any treatment. The combinations of Lipton yellow label tea extract with RELEAF™ statistically significantly increased root length by an average of 53% and root surface area by 68%. RELEAF™ alone increased root length by 10% not statistically significant and did not increase root surface area. With the exception of the low rate, there was a dose response with the higher rates producing more roots.

| | Treatments | Application rates | RL | | SA | |
|---|---|---|---|---|---|---|
| 1 | UTC | 0 | 374.4 | d | 101.4 | d |
| 2 | RELEAF | 5 L/Ha | 412.5 | cd | 101.3 | d |
| 3 | RELEAF ™ + Tea | 5 L/Ha + 125 | 538.3 | bc | 172.3 | b |
| | Extract | mL/Ha | | | | |
| 4 | RELEAF ™ + Tea | 5 L/Ha + 250 | 503.7 | bc | 139.1 | bcd |
| | Extract | mL/Ha | | | | |
| 5 | RELEAF ™ + Tea | 5 L/Ha + 500 | 575.4 | ab | 159.2 | bc |
| | Extract | mL/Ha | | | | |
| 6 | RELEAF ™ + Tea | 5 L/Ha + 1000 | 674.7 | a | 212.6 | a |
| | Extract | mL/Ha | | | | |

Means followed by same letter do not significantly differ (P = .05, Duncan's New MRT)

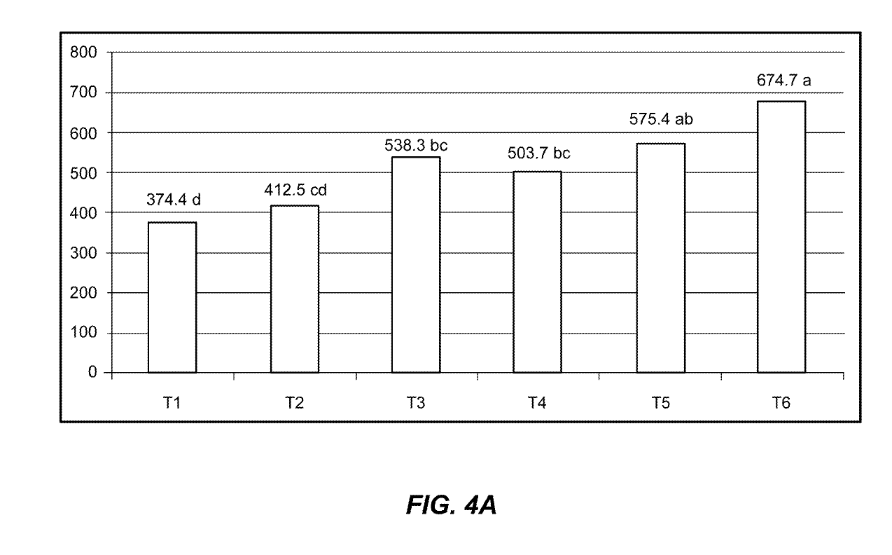

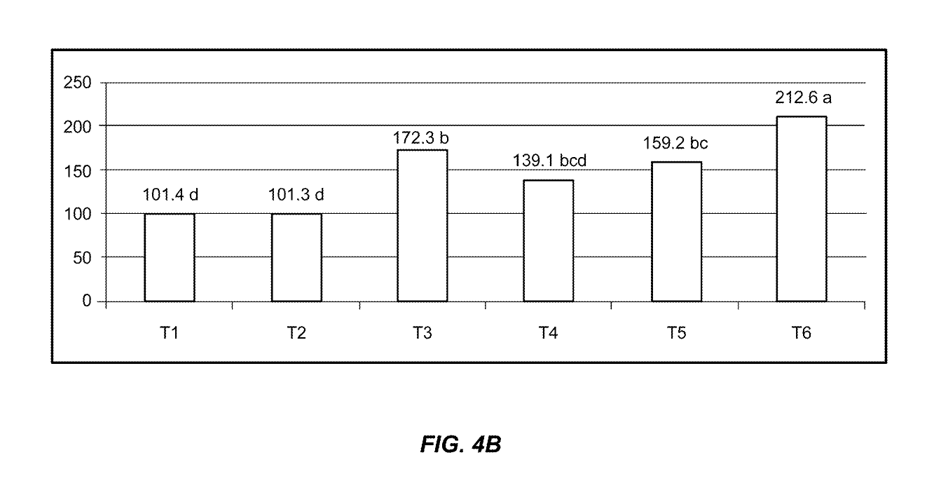

The results shown in the above table are also shown in FIGS. 4A and 4B.

### Conclusion:

The combinations of Lipton yellow label tea extract with RELEAF™ were safe for use on wheat and significantly increased root growth in wheat.

### Example 7

### Effect of Treating Seeds Using Black Tea Extract in Combination with Urea Fertilizer on Wheat Root Growth

### Materials and Methods:

A randomized complete block design experiment with 4 replicates was established in wheat (Superb) on a sandy clay loam (30% sand, 30% silt and 40% clay) soil. The previous crop was Roundup Ready canola. Plot size was 2 by 8 m.

Lipton yellow label tea extract was prepared by steeping 20 grams of tea leaves from tea bags in heated mineral water at 95° C. for 120 minutes. Urea fertilizer was obtained from Hamman AG Research Inc. (Lethbridge, Canada).

A conventional drum tumbler was used to impregnate urea with the tea extract. An appropriate volume of the tea extract was applied to the urea fertilizer using an atomizer to treat the urea fertilizer evenly and thoroughly. The urea fertilizer alone or treated with the tea extract was side banded during seeding.

For the root system measurements, the WinRhizo Pro 2012b (Regent Instr. Inc., Quebec, Canada) images analysis system was used, coupled with a professional scanner Epson XL 1000 equipped with additional light unit (TPU) (see, Arsenault et al., HortScience 30:906, 1995). For the images of root measurement the definition of 600 (dpi) was used. The root characteristics were determined as follows: total root length (RL) (cm) and root surface area (SA) (cm²).

The treatment protocol is listed in the table below.

| Treatments | Application Rates |
|---|---|
| Urea | 75% |
| Urea + Tea Extract | 75% + 500 mL/Ha |
| Urea + Tea Extract | 100% + 500 mL/Ha |

### Results:

No phytotoxicity was observed with any treatment. Lipton yellow label tea extract impregnated on 75% of the recommended rate of urea significantly increased root length by 79% and provided a 91% increase in root surface area. Lipton yellow label tea extract impregnated on 100% of the recommended rate of urea increased root length by 55% and root surface area by 135%.

The results are shown in the table below. The values shown in this table were obtained from 10 plants of each plot.

| Treatments | Application Rates | RL (cm) | SA (cm²) |
|---|---|---|---|
| Urea | 75% | 459.3 b | 100.7 b |
| Urea + Tea | 75% + 500 mL/Ha | 820.8 a | 192.5 a |
| Extract | | | |
| Urea + Tea | 100% + 500 mL/Ha | 710.7 a | 237.3 a |
| Extract | | | |

Means followed by same letter do not significantly differ (P = .05, Duncan's New MRT)

### Conclusion:

Lipton yellow label tea extract alone or in combination with urea was safe for use on wheat. Root length in wheat was increased on average by 67% while root surface area was increased by 113% with the combination treatments. These increases in wheat root growth were statistically significant. Urea impregnated with the tea extract significantly increased root growth in wheat.

### Example 8

### Effect of Treating Seeds Using Black Tea Extract in Combination with Precede™ on Wheat Root Growth

### Materials and Methods:

A randomized complete block design experiment with 4 replicates was established in wheat (Superb) on a sandy clay loam (30% sand, 30% silt and 40% clay) soil. The field was fertilized according to soil test recommendations. The previous crop was Roundup Ready canola. Plot size was 2 by 8 m.

Lipton yellow label tea extract was prepared by steeping 20 grams of tea leaves from the tea bags in heated mineral water at 95° C. for 120 minutes. PRECEDE™ (a nutritional seed treatment product) was obtained from ATP Nutrition (Oak Bluff, Manitoba, Canada).

Seed treatment employed a conventional drum tumbler which was used while applying the appropriate volume of tea extract plus PreCede™ using an atomizer to treat the seed evenly and thoroughly.

For the root system measurements, the WinRhizo Pro 2012b (Regent Instr. Inc., Quebec, Canada) images analysis system was used, coupled with a professional scanner Epson XL 1000 equipped with additional light unit (TPU) (see, Arsenault et al., HortScience 30:906, 1995). For the images of root measurement the definition of 600 (dpi) was used. The root characteristics were determined as follows: total root length (RL) (cm) and root surface area (SA) (cm²).

The treatment protocol is listed in the table below. The values shown in this table were obtained from 10 plants of each plot.

| Treatments | Application Rates |
|---|---|
| Untreated Control (UTC) | 0 |
| Tea Extract | 1.2 mL/Kg of seed |
| PRECEDE ™ + Tea Extract | 3 + 1.2 mL/Kg of seed |

### Results:

No phytotoxicity was observed with any treatment. Tea extract alone increased root length by 21% while increasing root surface area by 36%. Tea extract plus PRECEDE™ increased root length by 39%. Tea extract plus PRECEDE™ increased root surface area by 89%.

The results are shown in the table below.

| Treatments | Application Rates | RL (cm) | SA (cm²) |
|---|---|---|---|
| UTC | 0 | 870.7 c | 152.8 c |
| Tea Extract | 1.2 mL/Kg | 1053.9 b | 208.5 b |
| | of seed | | |
| PRECEDE ™ + Tea | 3 + 1.2 mL/Kg | 1213.2 a | 289.2 a |
| Extract | of seed | | |

Means followed by same letter do not significantly differ (P = .05, Duncan's New MRT)

### Conclusion:

Lipton yellow label tea extract alone or in combination with PRECEDE™ was safe for use on wheat. Root length in wheat was increased by 21% with the tea extract alone while root surface area was increased by 36%. The tea extract in combination with PRECEDE™ increased root length by 39% and root surface area by 89%. These increases in wheat root growth were statistically significant. The addition of PRECEDE™ to the tea extract provided a further increase in root length of 18% and a further increase in root surface area by 53%. The tea extract either alone or in combination with PRECEDE™ increased root growth in wheat.

### Example 9

### Effect of Black Tea Extract as Seed Treatment on Germination and Early Growth of Turf Grass

Darjeeling tea extract was made by steeping 20 grams of tea leaves in heated mineral water at 95° C. for 120 minutes.

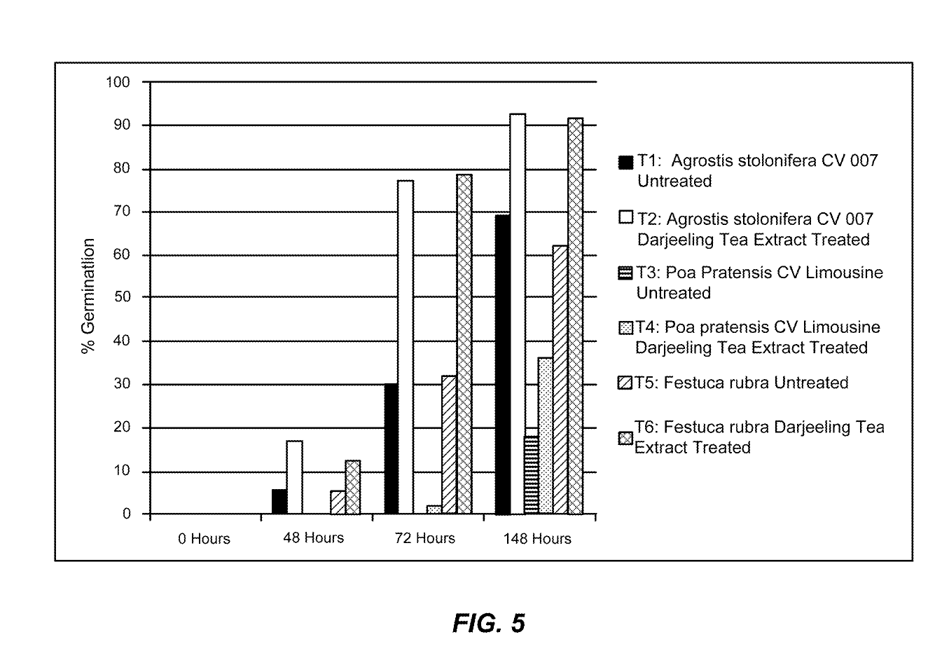

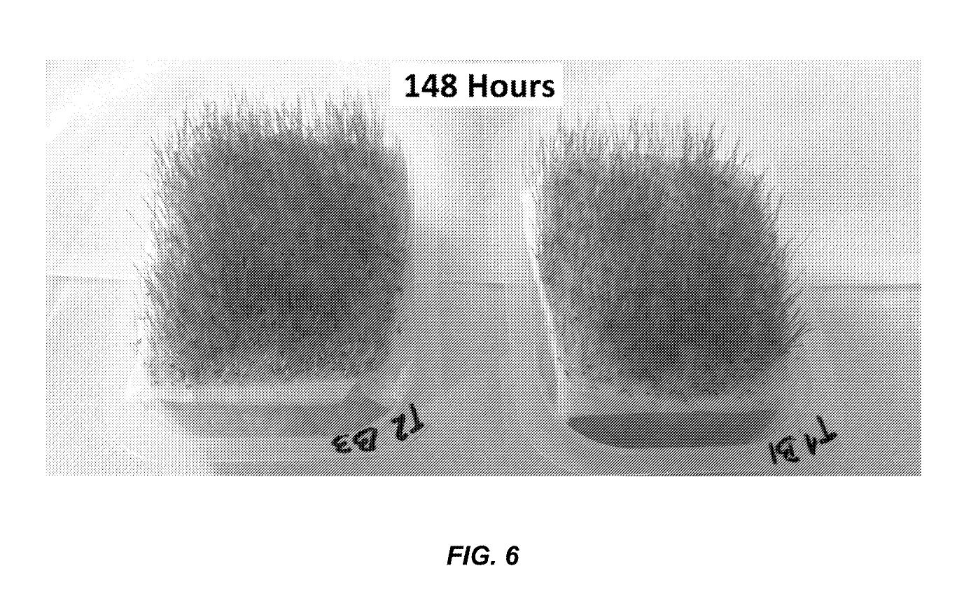

Studies have also been conducted on various species of sports turf seed. The results show that Darjeeling tea extract enhanced germination and early root and shoot growth for Poa praetensis, Festuca rubra, and bentgrass (Agrostis stononifera) (see, FIGS. 5 and 6).

Microscopic evaluations of the turf during germination and early growth indicated that Darjeeling tea extract treated turf seedlings had significantly less mortality from fungal seedling diseases, resulting in a greater final stand density (see, FIG. 6).

### Example 10

### Effect of Preservative on Promotion of Wheat Seedling Root Growth by Black Tea Extract

To evaluate whether a preservative affects the benefits of black tea extracts on wheat germination and early root growth, Malawi black tea extracts and Kenya black tea extracts were prepared according to Example 1 and used to treat wheat seeds (0.6 ml/kg seed) in combination with a preservative (1% solution of methyl paraben that has been predissolved in hexalene glycol (30:1 ratio of hexalene glycol to methyl paraben)) or without the preservative substantially according to Example 2. Root system measurements were performed according to Example 6.

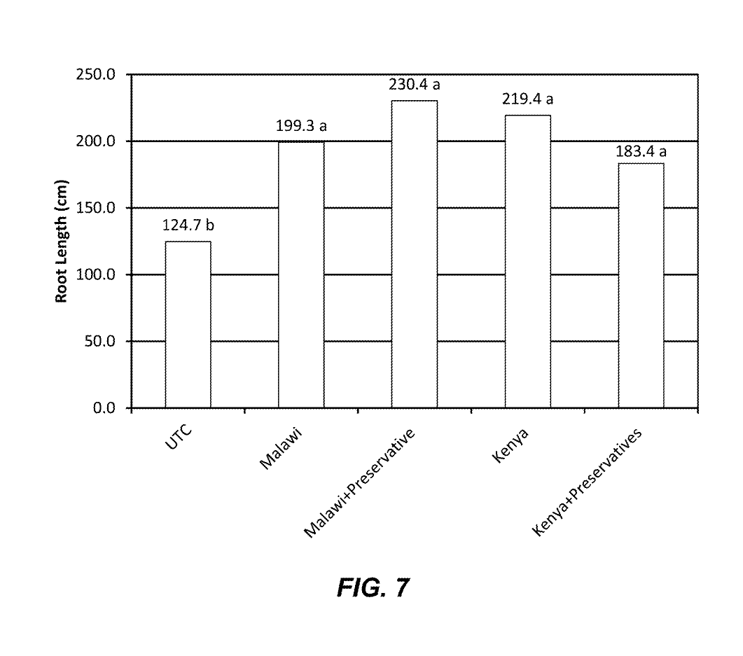

The results show that both Malawa black tea extract and Kenya black tea extract promoted root growth of wheat seedlings, and 1% of methyl paraben did not negatively affect such benefits of the black tea extracts (FIG. 7).

### Example 11

### Effects of Black Tea Extract on Germination and Seedling Vigor in Wheat Under Cold Temperatures

Germination and seedling growth tests were conducted to characterize the impact of a black tea extract on germination of seeds and growth of young seedlings under cold (12° C.) as well as normal (25° C.) temperatures. A black tea extract was prepared according to Example 1 and used to treat wheat seeds. Seed germination and growth of young seedlings (coleoptiles height, shoot dry matter yield, and root dry matter yield of wheat seedlings) were measured. In addition, the activities of ascorbate peroxidase (AP) and catalase during generation of wheat seeds treated with the black tea extract at normal and cold temperatures were also measured according to Cakmak et al., J. Exp. Bot. 44:127-32, 1993).

### Effect of Different Stress Conditions and Seed Treatment with Black Tea Extract on Germination of Wheat Grown in a Soil

| Stress | Dose | | Day 5 | |
|---|---|---|---|---|
| conditions | (ml/100 kg seed) | Day 3 | Germination rate, % | Day 6 |
| Normal | 0 | 87 ± 5 | 98 ± 3 | 98 ± 3 |
| Normal | 100 | 83 ± 4 | 98 ± 3 | 98 ± 3 |
| Normal | 400 | 90 ± 9 | 97 ± 4 | 97 ± 4 |
| Cold | 0 | — | 63 ± 17 | 97 ± 4 |
| Cold | 100 | — | 78 ± 8 | 95 ± 3 |
| Cold | 400 | — | 80 ± 14 | 92 ± 8 |

### Effect of Different Stress Conditions and Seed Treatment with Black Tea Extract on Coleoptile Height of Wheat Seedlings on Days of 5 and 8 after Germination

| | | | |
|---|---|---|---|
| Stress | Rate | Day 5 | Day 8 |

| | | |
|---|---|---|
| conditions | (ml/100 kg seed) | Plant height, g plant⁻¹ |

| | | | |
|---|---|---|---|
| Normal | 0 | 7.44 ± 0.35 | 12.56 ± 0.85 |
| Normal | 100 | 7.83 ± 0.44 | 12.68 ± 0.89 |
| Normal | 400 | 7.90 ± 0.37 | 13.18 ± 0.61 |
| Cold | 0 | 0.50 ± 0.24 | 4.28 ± 0.20 |
| Cold | 100 | 1.25 ± 0.29 | 5.28 ± 0.43 |
| Cold | 400 | 1.43 ± 0.56 | 5.68 ± 0.83 |

### Effect of Different Stress Conditions and Seed Treatment with Black Tea Extract on Shoot and Root Dry Matter Yield of 8 Days Old Wheat Seedlings

| | Dose | Shoot dry | Root dry |
|---|---|---|---|
| Stress | (ml/100 kg | matter | matter |
| conditions | seed) | (mg plant⁻¹) | (mg plant⁻¹) |
| Control 22-25° C. | 0 | 15.4 ± 0.7 | 11.1 ± 1.1 |
| Control 22-25° C. | 100 | 16.3 ± 1.5 | 12.0 ± 2.0 |
| Control 22-25° C. | 400 | 16.0 ± 0.8 | 10.7 ± 0.6 |
| Cold 10-12° C. | 0 | 4.6 ± 0.2 | 5.7 ± 0.5 |
| Cold 10-12° C. | 100 | 6.4 ± 0.5 | 6.2 ± 0.2 |
| Cold 10-12° C. | 400 | 7.2 ± 0.6 | 6.6 ± 0.6 |

| | Black Tea | AP | CATALASE |
|---|---|---|---|
| | Extract | Activity | Activity |
| Germination | treatment | (μmol/mg | (nmol/mg |
| Conditions | (ml/100 kg seed) | Prt./min) | Prt./min) |
| Normal 25° C. | 0 | 2.77 ± 0.32 | 98 ± 17 |
| Normal 25° C. | 400 ml | 3.01 ± 0.26 | 100 ± 9 |
| Cold 12° C. | 0 | 3.09 ± 0.29 | 73 ± 10 |
| Cold 12° C. | 400 ml | 3.21 ± 0.39 | 136 ± 38 |

The results show that the black tea extract promoted wheat seed early generation and growth of young seedlings under the cold temperature. In addition, the black tea extract significantly increased AP and catalase activities during generation of wheat seeds at cold temperatures, suggesting that the black tea extract improved adaptation ability of seeds to low temperature stress conditions.

### Example 12

### Effects of the Combination of Ascorbic Acid with Black Tea Extract on Wheat Germination

To evaluate whether ascorbic acid further promotes the beneficial effects of black tea extracts on wheat germination, black tea extracts were prepared according to Example 1 and used to treat wheat seeds at various concentrations in combination with ascorbic acid or without ascorbic acid substantially according to Example 2.

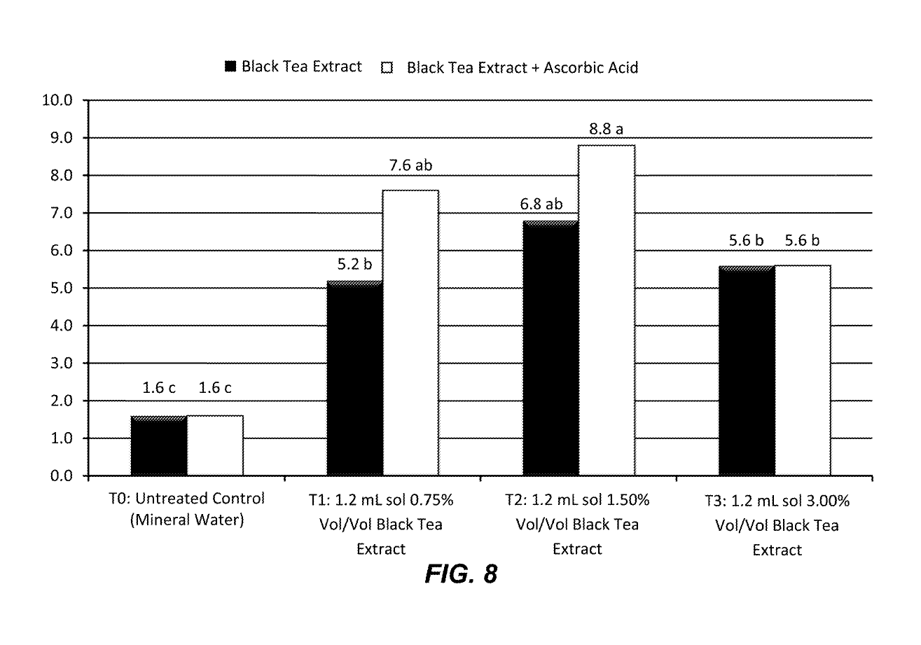

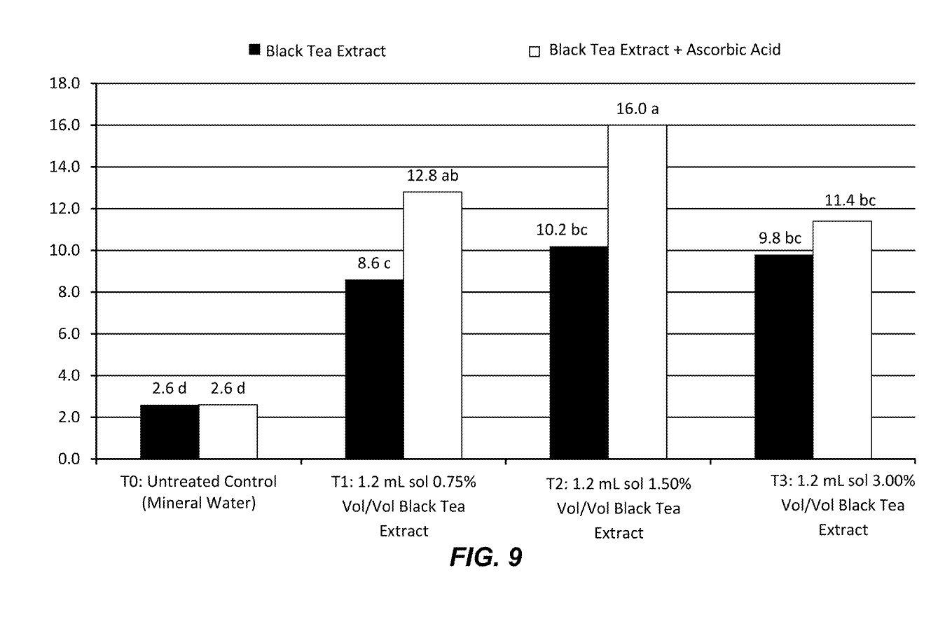

For each treatment (i.e., T1, T2 and T3), the amount of black tea extract indicated in FIGS. 8 and 9 was used for treating 30 g of wheat seeds. The concentration of ascorbic acid was 10.5 g per liter of black tea extracts prepared according to Example 1.

The results show that adding ascorbic acid to black tea extracts resulted in accelerated germination at even lower concentrations of black tea extracts (FIGS. 8 and 9).

### Example 13

### Effects of the Combination of Ascorbic Acid with Black Tea Extract on Wheat Seedling Growth

To evaluate whether ascorbic acid further promotes the beneficial effects of black tea extracts on the growth of wheat seedlings, black tea extracts were prepared according to Example 1 and used to treat wheat seeds at different concentrations in combination with ascorbic acid or without ascorbic acid. The concentration of ascorbic acid was 10.5 g per liter of black tea extracts prepared according to Example 1.

### Root Length and Plant Height of 5-Days-Old Wheat Seedlings as Affected by the Black Tea Extract Treatment with and without Ascorbic Acid

| | | Root | Plant |
|---|---|---|---|
| | Appl. Dose | Length | Height |
| Application | (ml/kg seed) | (cm) | (cm) |
| Control | 0 | 8.3 ± 1.4 | 1.6 ± 0.3 |
| Black Tea Extract | 0.5 | 10.0 ± 1.2 | 1.9 ± 0.3 |
| Black Tea Extract | 1.5 | 11.0 ± 0.9 | 2.3 ± 0.2 |
| Black Tea Extract | 0.5 | 10.4 ± 1.3 | 2.3 ± 0.2 |
| with Ascorbic Acid | | | |
| Black Tea Extract | 1.5 | 11.1 ± 1.0 | 2.5 ± 0.2 |
| with Ascorbic Acid | | | |

The results show that black tea extracts promoted wheat seedling growth, and adding ascorbic acid to black tea extracts further accelerated wheat seedling growth.

### Example 14

### Effects of the Combination of Ascorbic Acid with Black Tea Extract on Wheat Root Growth

To further evaluate whether ascorbic acid further promotes the beneficial effects of black tea extracts on wheat root growth, black tea extracts were prepared according to Example 1 and used to treat wheat seeds at different concentrations in combination with ascorbic acid or without ascorbic acid. The concentration of ascorbic acid was 10.5 g per liter of black tea extracts prepared according to Example 1.

### Root Length and Surface Area (SA) as Affected by the Black Tea Extract Treatment with and without Ascorbic Acid

| | Application | Root | | | |
|---|---|---|---|---|---|
| | Rates | Length | | SA | |
| Application | (ml/kg seed) | (mm) | | (cm²) | |
| Untreated | 0 | 118.4 | e | 31.8 | c |
| Control | | | | | |
| Black Tea | 0.3 mL/Kg | 163.8 | d | 39 | b |
| Extract | Seed | | | | |
| Black Tea | 0.6 mL/Kg | 182.6 | cd | 42.1 | ab |
| Extract | Seed | | | | |
| Black Tea | 0.9 mL/Kg | 157.7 | d | 41.7 | ab |
| Extract | Seed | | | | |
| Black Tea | 1.2 mL/Kg | 161.2 | d | 39.9 | ab |
| Extract | Seed | | | | |
| Black Tea | 2.4 mL/Kg | 180.7 | cd | 42.8 | ab |
| Extract with | Seed | | | | |
| Ascorbic Acid | | | | | |
| Black Tea | 0.3 mL/Kg | 159.6 | d | 40.6 | ab |
| Extract with | Seed | | | | |
| Ascorbic Acid | | | | | |
| Black Tea | 0.6 mL/Kg | 160.9 | d | 42 | ab |
| Extract with | Seed | | | | |
| Ascorbic Acid | | | | | |
| Black Tea | 0.9 mL/Kg | 208 | bc | 45.8 | a |
| Extract with | Seed | | | | |
| Ascorbic Acid | | | | | |

Means followed by same letter do not significantly differ (P = .05, Duncan's New MRT)

The results show that black tea extracts promoted wheat root growth, and adding ascorbic acid to black tea extracts further accelerated wheat root growth.

### Example 15

### Effects of the Black Tea Extract on Growth and Yield of Pulse Plants

### Materials and Methods

Four field trials were conducted: two in peas and two in soybeans.

The appropriate seed volumes were placed in plastic Ziploc bags. The appropriate amounts of biostimulants were applied to the seed using a syringe. The seed was then shaken inside the bags to ensure thorough and even coverage. The pea trial evaluated black tea extract alone and in combination with other biostimulants. The pea treatments were:

| | Treatment | Rate |
|---|---|---|
| 1. | Untreated | 0 ml/kg seed |
| 2. | Ascend | 1 ml/kg seed |
| 3. | Ecolicitor | 3 ml/kg seed |
| 4. | Kelpak | 1 ml/kg seed |
| 5. | Acadian | 3 ml/kg seed |
| 6. | Black tea extract | 0.25 ml/kg seed |
| 7. | ASCEND ® + Black tea extract | 1 + 0.25 ml/kg seed |
| 8. | ECOLICITOR ® + Black tea extract | 3 + 0.25 ml/kg seed |
| 9. | Kelpak + Black tea extract | 1 + 0.25 ml/kg seed |
| 10. | Acadian + Black tea extract | 3 + 0.25 ml/kg seed |

ASCEND ® plant growth regulator contains a combination of 3 plant growth regulators (cytokinin 0.090%, gibberellic acid 0.030%, and indolebutyric acid 0.045%) that is available from WinField.
ECOLICITOR ® is a concentrated solution of bioactive components extracted from Ascophyilum nodosum, commercially available from, for example, BioAtlantis, Ireland.
Kelpak, derived from the seaweed species Ecklonia Maxima (Kelp), is a natural and unique source of Auxins and Cytokinins, commercially available from, for example, Kelp Products (Pty) Ltd, South Africa.
Acadian, derived from the seaweed species Ascophylum nodosum (North Atlantic or North Sea Kelp) is a natural source of Cytokinins, polyphenols, free amino acids, alpha tocopherol (Vitamin E) and other natural plant derived compounds.

The soybean trial evaluated three rates of black tea extract. The soybean treatments were:

| | |
|---|---|
| Treatment | Rate |

| | | | |
|---|---|---|---|
| 1. | Untreated | 0 | ml/kg seed |
| 2. | Black tea extract | 0.25 | ml/kg seed |
| 3. | Black tea extract | 0.375 | ml/kg seed |
| 4. | Black tea extract | 0.5 | ml/kg seed |

Seed was sown using a small plot planter at recommended seeding rates in a randomized complete block design. Each trial was fertilized with the recommended rates of nutrients as discerned by soil tests. The appropriate rate of nitrogen inoculant was applied to the seed and soil in each trial. Ten plants were sampled from each treatment at about the 2 leaf stage in peas and the first trifoliate stage in soybeans. The roots were washed, and the root length and surface area of the plants in each treatment were determined by winrhizo analysis. Winrhizo analyses consisted of taking 3 dimensional pictures of roots to determine the total root lengths and surface areas.

At approximately 4 weeks after emergence, ten plants were sampled from each plot. The roots were washed, and the number of nodules per plant was counted to determine the average number of nodules per plant in each treatment.

At maturity, each plot was harvested using a small plot combined. The plot seed was weighed, tested and adjusted for moisture content to determine the average yield for each treatment.

### Results and Discussion

### Pea Trials:

Black tea extract increased the root surface area by an average of 31% (Table 1), which was substantially more than any other biostimulant. The black tea extract applications with other biostimulants tended to produce more rooting than any treatment applied alone, indicating some synergy between black tea extract and the other products.

### Root Lengths and Surface Areas as Determined by Winrhizo Scanning

Pea Root Length and Root Surface Area
Compiled Data (Sum of 2 Trials)

| | | | Actual | | | |
|---|---|---|---|---|---|---|
| | | | values | | % | |
| TRT | | | RL | RSA | Increase | |
| # | Treatment | Rate | (cm) | (cm²) | RL | RSA |
| 1 | Untreated Check | 0 | 630 | 192 | 0 | 0 |
| 2 | Ascend | 1 ml/kg | 569 | 207 | −10 | 8 |
| 3 | Ecolicitor | 3 ml/kg | 634 | 210 | 1 | 9 |
| 4 | Kelpak | 1 ml/kg | 571 | 202 | −9 | 5 |
| 5 | Acadian | 3 ml/kg | 585 | 223 | −7 | 16 |
| 6 | Black Tea Extract | 0.25 ml/kg | 752 | 252 | 19 | 31 |
| 7 | Ascend + Black | 1 + 0.25 | 793 | 254 | 26 | 32 |
| | Tea Extract | ml/kg | | | | |
| 8 | Ecolicitor + Black | 3 + 0.25 | 829 | 239 | 32 | 24 |
| | Tea Extract | ml/kg | | | | |
| 9 | Kelpak + Black | 1 + 0.25 | 954 | 269 | 52 | 40 |
| | Tea Extract | ml/kg | | | | |
| 10 | Acadian + Black | 3 + 0.25 | 661 | 238 | 5 | 24 |
| | Tea Extract | ml/kg | | | | |

RL = Root Length;
RSA = Root Surface Area

Due to dry conditions, nodulation data was not obtained at one field trial. However, black tea extract increased nodulation by 15% in peas in the trial where nodulation data was available (see, Table below). There appeared to some synergy with respect to nodulation in the black tea extract and Kelpak treatment, but not with the other biostimulants.

### Treatment Effects on Pea Nodulation

Pea Nodulation (1 Trial)

| TRT | | | Nodules/ | % |
|---|---|---|---|---|
| # | Treatment | Rate | plant | Increase |
| 1 | Untreated Check | 0 | 13.8 | 0 |
| 2 | Ascend | 1 ml/kg | 11.9 | −14 |
| 3 | Ecolicitor | 3 ml/kg | 23.2 | 68 |
| 4 | Kelpak | 1 ml/kg | 11.9 | −14 |
| 5 | Acadian | 3 ml/kg | 11.0 | −20 |
| 6 | Black Tea Extract | 0.25 ml/kg | 15.9 | 15 |
| 7 | Ascend + Black Tea | 1 + 0.25 ml/kg | 13.5 | −2 |
| | Extract | | | |
| 8 | Ecolicitor + Black Tea | 3 + 0.25 ml/kg | 10.0 | −28 |
| | Extract | | | |
| 9 | Kelpak + Black Tea | 1 + 0.25 ml/kg | 24.8 | 80 |
| | Extract | | | |
| 10 | Acadian + Black Tea | 3 + 0.25 ml/kg | 14.1 | 2 |
| | Extract | | | |

In each of the two trials, the black tea extract treated plots yielded more than the checks, providing an average yield increase of 7% (see, the Table below). There was no apparent synergy between black tea extract and the other biostimulants with respect to yield.

### Pea Yields

Pea Yield Compiled Data (sum of 2 trials)

| | | | Yield | % |
|---|---|---|---|---|
| TRT # | Treatment | Rate | (kg/ha) | Increase |
| 1 | Untreated Check | 0 | 2991 | 0 |
| 2 | Ascend | 1 ml/kg | 3081 | 3 |
| 3 | Ecolicitor | 3 ml/kg | 3061 | 2 |
| 4 | Kelpak | 1 ml/kg | 3112 | 4 |
| 5 | Acadian | 3 ml/kg | 3274 | 9 |
| 6 | Black Tea Extract | 0.25 ml/kg | 3201 | 7 |
| 7 | Ascend + Black Tea | 1 + 0.25 ml/kg | 3255 | 9 |
| | Extract | | | |
| 8 | Ecolicitor + Black Tea | 3 + 0.25 ml/kg | 3044 | 2 |
| | Extract | | | |
| 9 | Kelpak + Black Tea | 1 + 0.25 ml/kg | 3203 | 7 |
| | Extract | | | |
| 10 | Acadian + Black Tea | 3 + 0.25 ml/kg | 3278 | 10 |
| | Extract | | | |

### Soybean Trials:

The black tea extract increased soybean root length and root surface area by 44% and 51%, respectively (see the Table below). The 0.5 ml/kg seed rate of black tea extract provided the most root length while only the 0.25 ml/kg seed rate was required to provide the most root surface area (RSA). RSA is the primary indicator of root growth, as it indicates the total volume of root growth.

### Root Length and Surface Area as Determined by Winrhizo Analyses

Soybean Root Length and Root Surface
Area Compiled Data (Sum of 2 Trials)

| | | | | Actual | | | |
|---|---|---|---|---|---|---|---|
| | | | | values | | % | |
| TRT | | | | RL | RSA | Increase | |
| # | Treatment | Rate | | (cm) | (cm²) | RL | RSA |
| 1 | Untreated Check | 0 | | 537 | 138 | 0 | 0 |
| 2 | Black Tea Extract | 0.25 | ml/kg | 698 | 209 | 30 | 51 |
| 3 | Black Tea Extract | 0.375 | ml/kg | 650 | 166 | 21 | 20 |
| 4 | Black Tea Extract | 0.5 | ml/kg | 771 | 202 | 44 | 46 |

RL = Root Length;
RSA = Root Surface Area

The 0.25 ml/kg seed rate of black tea extract increased nodulation by 33% (see the Table below). There was no further black tea extract rate response with respect to nodulation.

### Soybean Nodule Counts

Soybean Nodulation Compiled Data (Sum of 2 Trials)

| | | | | Nodules/ | % |
|---|---|---|---|---|---|
| TRT # | Treatment | Rate | | Plant | Increase |
| 1 | Untreated Check | 0 | | 14.1 | 0 |
| 2 | Black Tea Extract | 0.25 | ml/kg | 18.8 | 33 |
| 3 | Black Tea Extract | 0.375 | ml/kg | 17.3 | 23 |
| 4 | Black Tea Extract | 0.5 | ml/kg | 16.7 | 18 |

The soybean yield is available in only one trial. The results show that all treated plots yielded higher than the check in this trial (see the Table below). Black tea extract increased yields by up to 5% (0.375 ml/kg rate).

### Soybean Yields

Soybean Yield (one trial)

| | | | | Yield | % |
|---|---|---|---|---|---|
| TRT # | Treatment | Rate | | (kg/ha) | Increase |
| 1 | Untreated Check | 0 | | 3221 | 0 |
| 2 | Black Tea Extract | 0.25 | ml/kg | 3253 | 1.0 |
| 3 | Black Tea Extract | 0.375 | ml/kg | 3373 | 4.8 |
| 4 | Black Tea Extract | 0.5 | ml/kg | 3343 | 3.9 |

### Summary

Black tea extract is a novel plant extract shown to have stimulative properties in pulse crops. Trials to date show that black tea extract increased rooting in pulse crops which in turn resulted in higher nodulation and presumably greater nitrogen fixation, and thus better nitrogen use efficiency. The benefits provided by black tea extract applications increase pea and soybean yields at relatively low rates of application.

### Example 16

### Effects of Black Tea Extract on Canola Yield

The effects of black tea extract on canola yield were analyzed in a field trial. The results show that black tea extract improved canola yield (see the Table below).

| | Rate | Average Yield | % Change over |
|---|---|---|---|
| Treatment | (ml/kg seed) | (bu/ac) | control |
| Check | 0 | 44.9 | — |
| Black Tea Extract | 0.5 | 46.6 | 3.7 |
| Black Tea Extract | 0.75 | 50.1 | 11.5 |
| Black Tea Extract | 1 | 50.9 | 13.2 |

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Application No. 61/715,745, filed Oct. 18, 2012, and U.S. application Ser. No. 13/827,923, filed on Mar. 14, 2013 to which the present application claims priority, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for promoting plant growth, health or yield, comprising: treating at least a portion of a plant with an extract of oxidized tea at an amount effective in promoting growth, health or yield of the plant.

2. The method of claim 1, wherein the plant is a crop plant.

3. The method of claim 1, wherein the plant is a pulse plant.

4. The method of claim 1, wherein the plant is corn, soybean, pea, wheat, barley, oats, rice, canola, or turf grass.

5. The method of any of claims 1 to 4, wherein the oxidized tea is black tea.

6. The method of any of claims 1 to 5, wherein the extract comprises at least 15% thearubigins by dry weight.

7. The method of any of claims 1 to 6, wherein the extract is applied to soil around the plant.

8. The method of any of claims 1 to 6, wherein the portion of a plant is a seed, one or more leaves, one or more stems, one or more roots, or a combination thereof.

9. The method of any of claims 1 to 6, wherein the step of treating comprises priming a seed with the extract.

10. The method of any of claims 1 to 9, wherein the extract increases or enhances one or more of seed germination rate, seed germination potential and final stand, root length, root surface area, early vegetative growth of the plant, root to shoot ratio, rhizosphere, root nodule formation, plant vigor, flowering rate, maturity rate, seedling disease suppression, nematode suppression, chlorophyll density, pollination success, grain fill, plant yield, and plant protein content.

11. The method of any of claims 1 to 10, further comprising treating the portion of the plant with one or more additional plant protection or nutritional components.

12. The method of claim 11, wherein the one or more additional plant protection or nutritional components are selected from fertilizers, inoculants, biostimulants, and plant protection chemicals.

13. The method of claim 12, wherein the additional plant protection or nutritional component is a fertilizer that comprises plant micronutrient(s) iron, zinc, or both.

14. The method of claim 12, wherein the additional plant protection or nutritional component is a biostimulant selected from plant hormones, seaweed extracts, and humic substances.

15. The method of claim 12, wherein the additional plant protection or nutritional component is ascorbic acid.

16. The method of claim 12, wherein the additional crop protection or nutritional component is a plant protection chemical selected from herbicides, insecticides, and fungicides.

17. The method of any of claims 11 to 16, wherein the portion of the plant is treated with a composition comprising the extract and the one or more additional plant protection or nutritional components.

18. The method of claim 17, wherein the composition further comprises a preservative.

19. The method of claim 17 or 18, wherein the composition further comprises a stabilizer.

20. The method of any of claims 17 to 19, wherein the composition further comprises a seed priming agent.

21. A composition, comprising:
(i) an extract of oxidized tea, and
(ii) one or more additional plant protection or nutritional components other than carrageenan or ascorbic acid.

22. The composition of claim 21, wherein the oxidized tea is black tea.

23. The composition of claim 21 or 22, wherein the extract comprises at least 15% thearubigins by dry weight.

24. The composition of any of claims 21 to 23, wherein the one or more additional plant protection or nutritional components are selected from fertilizers, inoculants, biostimulants, and plant protection chemicals.

25. The composition of claim 24, wherein the additional plant protection or nutritional component is a fertilizer that comprises plant micronutrient(s) iron, zinc, or both.

26. The composition of claim 24, wherein the additional plant protection or nutritional component is a biostimulant selected from plant hormones and humic substances.

27. The composition of claim 24, wherein the additional plant protection or nutritional component is a plant protection chemical selected from herbicides, insecticides, and fungicides.

28. A seed composition, comprising:
(i) an extract of oxidized tea, and
(ii) a seed.

29. The seed composition of claim 28, wherein the oxidized tea is black tea.

30. The seed composition of claim 28 or 29, wherein the extract comprises at least 50% thearubigins by dry weight.

31. The seed composition of any of claims 28 to 30, further comprising one or more additional plant protection or nutritional components.

32. The seed composition of claim 31, wherein the one or more additional plant protection or nutritional components are selected from fertilizers, inoculants, biostimulants, and plant protection chemicals.

33. The seed composition of claim 32, wherein the additional plant protection or nutritional component is a fertilizer that comprises plant micronutrient(s) iron, zinc, or both.

34. The seed composition of claim 32, wherein the additional plant protection or nutritional component is a biostimulant selected from plant hormones, seaweed extracts, and humic substances.

35. The seed composition of claim 32, wherein the additional plant protection or nutritional component is ascorbic acid.

36. The seed composition of claim 32, wherein the additional plant protection or nutritional component is a plant protection chemical selected from herbicides, insecticides, and fungicides.

37. The seed composition of any of claims 28 to 36, further comprising
(iii) a preservative.

38. The seed composition of any of claims 28 to 37, further comprising
(iv) a stabilizer.

39. The seed composition of any of claims 28 to 38, further comprising
(v) a seed priming agent.

40. The seed composition of any of claims 28 to 39, wherein the seed is a seed of a crop plant.

41. The seed composition of any of claims 28 to 39, wherein the seed is a seed of corn, soybean, wheat, barley, oats, rice, canola, or turf grass.

42. The seed composition of any of claims 28 to 41, wherein the seed is coated with the extract.

43. The seed composition of claim 42, further comprises a second coating.

44. The seed composition of any of claims 28 to 41, wherein the seed has been primed with the extract.

45. The seed composition of any of claims 28 to 41, wherein the seed is soaked with the extract.
